(19) United States
(12) Patent Application Publication
(10) Pub. No.: US 2026/0189999 A1
(43) Pub. Date: Jul. 2, 2026

(54) METHOD AND APPARATUS FOR MANAGING CELL RESELECTION PRIORITY OF UE IN NEXT-GENERATION MOBILE COMMUNICATION SYSTEM

(71) Applicant: SAMSUNG ELECTRONICS CO., LTD., Suwon-si, Gyeonggi-do (KR)

(72) Inventors: Sangyeob JUNG, Suwon-si (KR); Anil AGIWAL, Suwon-si (KR)

(21) Appl. No.: 18/995,077

(22) PCT Filed: May 23, 2023
(86) PCT No.: PCT/KR2023/007008

§ 371 Date: Jan. 15, 2025

(30) Foreign Application Priority Data
Jul. 20, 2022 (KR) 10-2022-0089653

(51) Int. Cl. H04W 36/08; H04W 36/00; H04W 84/06

(52) U.S. Cl. CPC H04W 36/08; H04W 36/0058; H04W 84/06

(57) ABSTRACT

The present disclosure relates to a 5G or 6G communication system for supporting higher data transmission rates. The present disclosure relates to a method and apparatus for cell reselection of a UE. The present disclosure relates to a method performed by a UE having an unscrewed aerial vehicle (UAV) in a wireless communication system and an apparatus for performing same. The method comprises the steps of: receiving, from a base station, system information including at least one of a first cell reselection priority (CRP) or a second CRP for each of a plurality of frequencies; determining cell reselection priority for the plurality of frequencies on the basis of the system information; measuring frequencies on the basis of the cell reselection priority for the plurality of frequencies; and reselecting a cell that satisfies cell reselection criteria on the basis of the frequency measurement, wherein the first CRP is a CRP defined for an existing UAV UE, and the second CRP is a CRP defined for a UE having a UAV function.

### TECHNICAL FIELD

The disclosure relates to a method and apparatus for managing the cell reselection priority of a terminal in a next-generation mobile communication system.

### BACKGROUND ART

Fifth generation (5G) mobile communication technology defines a wide frequency band to enable fast transmission speed and new services, and can be implemented not only in a sub-6 GHz frequency band (“sub 6 GHz”) such as 3.5 GHz but also in an ultra-high frequency band (“above 6 GHz”) called mmWave such as 28 GHz or 39 GHz. In addition, 6G mobile communication technology called “beyond 5G system” is being considered for implementation in a terahertz (THz) band (e.g., band of 95 GHz to 3 THz) to achieve transmission speed that is 50 times faster and ultra-low latency that is reduced to 1/10 compared with 5G mobile communication technology.

In the early days of 5G mobile communication technology, to meet service support and performance requirements for enhanced mobile broadband (eMBB), ultra-reliable and low-latency communication (URLLC), and massive machine-type communications (mMTC), standardization has been carried out regarding beamforming for mitigating the pathloss of radio waves and increasing the propagation distance thereof in the mmWave band, massive MIMO, support of various numerology for efficient use of ultra-high frequency resources (e.g., operating multiple subcarrier spacings), dynamic operations on slot formats, initial access schemes to support multi-beam transmission and broadband, definition and operation of bandwidth parts (BWP), new channel coding schemes such as low density parity check (LDPC) codes for large-capacity data transmission and polar codes for reliable transmission of control information, L2 pre-processing, and network slicing for providing a dedicated network specialized for a specific service.

Currently, discussions are underway to improve 5G mobile communication technology and enhance performance thereof in consideration of the services that the 5G mobile communication technology has initially intended to support, and physical layer standardization is in progress for technologies such as V2X (Vehicle-to-Everything) that aims to help a self-driving vehicle to make driving decisions based on its own location and status information transmitted by vehicles and to increase user convenience, new radio unlicensed (NR-U) for the purpose of system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as intelligent factories (industrial Internet of things, IIoT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access (2-step RACH for NR) that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its location.

When such a 5G mobile communication system is commercialized, connected devices whose number is explosively increasing will be connected to the communication networks; accordingly, it is expected that enhancement in function and performance of the 5G mobile communication system and the integrated operation of the connected devices will be required. To this end, new research will be conducted regarding 5G performance improvement and complexity reduction, AI service support, metaverse service support, and drone communication by utilizing extended reality (XR) for efficiently supporting augmented reality (AR), virtual reality (VR), and mixed reality (MR), artificial intelligence (AI), and machine learning (ML).

Further, such advancement of 5G mobile communication systems will be the basis for the development of technologies such as new waveforms for ensuring coverage in the terahertz band of 6G mobile communication technology, full dimensional MIMO (FD-MIMO), multi-antenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes artificial intelligence (AI) from the design stage and internalizes end-to-end AI support functions to realize system optimization, and next-generation distributed computing that realizes services whose complexity exceeds the limit of terminal computing capabilities by utilizing ultra-high-performance communication and computing resources.

### DISCLOSURE

### Technical Problem

A technical objective to be achieved in various embodiments of the disclosure is to provide a method and apparatus for managing the cell reselection priority of a terminal in a mobile communication system.

In addition, a technical objective to be achieved in various embodiments of the disclosure is to provide a cell reselection method and apparatus for an aerial terminal in a mobile communication system.

### Technical Solution

According to various embodiments of the disclosure, a method performed by a terminal having an unscrewed aerial vehicle (UAV) function in a wireless communication system may include: receiving system information including at least one of a first cell reselection priority (CRP) or a second CRP for each of multiple frequencies from a base station; determining cell reselection priorities for the multiple frequencies based on the system information; performing frequency measurements based on the cell reselection priorities for the multiple frequencies; and reselecting a cell that satisfies cell reselection criteria based on the frequency measurements, wherein the first CRP is a CRP defined for a legacy UAV terminal, and the second CRP is a CRP defined for a terminal having a UAV function.

In addition, according to various embodiments of the disclosure, a terminal having an unscrewed aerial vehicle (UAV) function in a wireless communication system may include: a transceiver; and a controller, wherein the controller may be configured to control: receiving system information including at least one of a first cell reselection priority (CRP) or a second CRP for each of multiple frequencies from a base station; determining cell reselection priorities for the multiple frequencies based on the system information; performing frequency measurements based on the cell reselection priorities for the multiple frequencies; and reselecting a cell that satisfies cell reselection criteria based on the frequency measurements, wherein the first CRP may be a CRP defined for a legacy UAV terminal, and the second CRP may be a CRP defined for a terminal having a UAV function. The technical objectives to be achieved in various embodiments of the disclosure are not limited to those mentioned above, and other technical objectives not mentioned will be clearly understood by those skilled in the art to which the disclosure belongs from the following description.

### Advantageous Effects

According to various embodiments of the disclosure, it is possible to provide a method and apparatus for managing the cell reselection priority of a terminal in a mobile communication system.

In addition, according to various embodiments of the disclosure, it is possible to provide a cell reselection method and apparatus for an aerial terminal in a mobile communication system.

### DESCRIPTION OF DRAWINGS

FIG. 1 is a diagram illustrating the architecture of an LTE system according to an embodiment of the disclosure.

FIG. 2 is a diagram illustrating the structure of radio protocols in an LTE system according to an embodiment of the disclosure.

FIG. 3 is a diagram illustrating the architecture of a next-generation mobile communication system according to an embodiment of the disclosure.

FIG. 4 is a diagram illustrating the structure of radio protocols in a next-generation mobile communication system according to an embodiment of the disclosure.

FIG. 5 is a diagram depicting a cell reselection procedure performed by a UE in a next-generation mobile communication system according to an embodiment of the disclosure

FIG. 6 is a diagram depicting a cell reselection procedure performed by an aerial UE in a next-generation mobile communication system according to an embodiment of the disclosure.

FIG. 7 is a diagram depicting a cell reselection procedure performed by an aerial UE in a next-generation mobile communication system according to an embodiment of the disclosure.

FIG. 8 is a diagram depicting a cell reselection procedure performed by an aerial UE in a next-generation mobile communication system according to an embodiment of the disclosure.

FIG. 9 is a diagram depicting a cell reselection procedure performed by an aerial UE in a next-generation mobile communication system according to an embodiment of the disclosure.

FIG. 10 is a diagram depicting a cell reselection procedure performed by an aerial UE in a next-generation mobile communication system according to an embodiment of the disclosure.

FIG. 11 is a diagram illustrating the structure of a UE according to an embodiment of the disclosure.

FIG. 12 is a diagram illustrating the structure of a base station according to an embodiment of the disclosure.

### MODE FOR DISCLOSURE

Hereinafter, preferred embodiments of the disclosure will be described in detail with reference to the accompanying drawings. Here, it should be noted that in the attached drawings, the same components are indicated by the same symbols as possible. In addition, detailed descriptions of known functions and configurations that may obscure the gist of the disclosure will be omitted.

In the following description of embodiments, descriptions of technical details well known in the art and not directly related to the disclosure may be omitted. This is to more clearly convey the subject matter of the disclosure without obscurities by omitting unnecessary descriptions.

Likewise, in the drawings, some elements are exaggerated, omitted, or only outlined in brief. Also, the size of each element does not necessarily reflect the actual size. The same or similar reference symbols are used throughout the drawings to refer to the same or like parts.

Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims. The same reference symbols are used throughout the description to refer to the same parts.

Meanwhile, it will be appreciated that blocks of a flowchart and a combination of flowcharts may be executed by computer program instructions. These computer program instructions may be loaded on a processor of a general purpose computer, special purpose computer, or programmable data processing equipment, and the instructions executed by the processor of a computer or programmable data processing equipment create a means for carrying out functions described in blocks of the flowchart. To implement the functionality in a certain way, the computer program instructions may also be stored in a computer usable or readable memory that is applicable in a specialized computer or a programmable data processing equipment, and it is possible for the computer program instructions stored in a computer usable or readable memory to produce articles of manufacture that contain a means for carrying out functions described in blocks of the flowchart. As the computer program instructions may be loaded on a computer or a programmable data processing equipment, when the computer program instructions are executed as processes having a series of operations on a computer or a programmable data processing equipment, they may provide steps for executing functions described in blocks of the flowchart.

Further, each block of a flowchart may correspond to a module, a segment or a code containing one or more executable instructions for executing one or more logical functions, or to a part thereof. It should also be noted that functions described by blocks may be executed in an order different from the listed order in some alternative cases. For example, two blocks listed in sequence may be executed substantially at the same time or executed in reverse order according to the corresponding functionality.

Here, the word “unit”, “module”, or the like used in the embodiments may refer to a software component or a hardware component such as an FPGA or ASIC capable of carrying out a function or an operation. However, “unit” or the like is not limited to software or hardware. A unit or the like may be configured so as to reside in an addressable storage medium or to drive one or more processors. For example, units or the like may refer to components such as a software component, object-oriented software component, class component or task component, processes, functions, attributes, procedures, subroutines, program code segments, drivers, firmware, microcode, circuits, data, databases, data structures, tables, arrays, or variables. A function provided by a component and unit may be a combination of smaller components and units, and it may be combined with others to compose larger components and units. Further, components and units may be implemented to drive one or more processors in a device or a secure multimedia card.

In the following description, the term “base station” refers to a main agent allocating resources to terminals and may be at least one of Node B, BS, eNB (eNode B), gNB (gNode B), radio access unit, base station controller, or network node. The term “terminal” may refer to at least one of user equipment (UE), mobile station (MS), cellular phone, smartphone, computer, or multimedia system with a communication function. Additionally, the embodiments of the disclosure may be applied to other communication systems having similar technical backgrounds or channel types as the embodiments of the disclosure described below. In addition, the embodiments of the disclosure may be applied to other communication systems through some modifications without significantly departing from the scope of the disclosure. For example, this may include the 5^{th} generation mobile communication technology (5G, new radio, NR) developed after LTE-A, and the term 5G hereinafter may be a concept that includes existing LTE, LTE-A, and other similar services. Further, it should be understood by those skilled in the art that the disclosure is applicable to other communication systems without significant modifications departing from the scope of the disclosure.

Those terms used in the following description for identifying an access node, indicating a network entity or network function (NF), indicating a message, indicating an interface between network entities, and indicating various identification information are taken as illustration for ease of description. Hence, the disclosure is not limited by the terms to be described later, and other terms referring to objects having an equivalent technical meaning may be used.

For convenience of explanation, some terms and names defined in the 3GPP (3rd generation partnership project) LTE (long term evolution) standards and/or 3GPP NR (new radio) standards may be used in the following description. However, the disclosure is not limited by the above terms and names, and may be equally applied to systems complying with other standards.

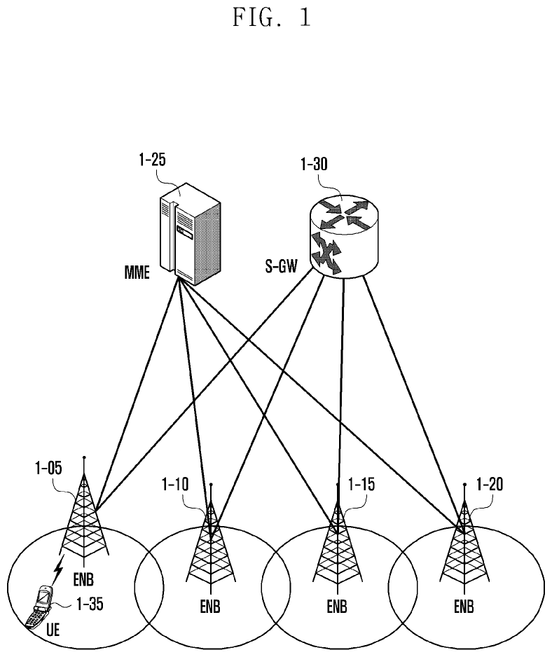

FIG. 1 is a diagram illustrating the architecture of an LTE system according to an embodiment of the disclosure.

With reference to FIG. 1, as illustrated, the radio access network of the LTE system may be composed of a next-generation base station (evolved node B, ENB, Node B or base station) 1-05, 1-10, 1-15 or 1-20, a mobility management entity (MME) 1-25, and a serving-gateway (S-GW) 1-30. A user equipment (UE or terminal) 1-35 may connect to an external network through the ENB 1-05, 1-10, 1-15 or 1-20 and the S-GW 1-30.

In FIG. 1, the ENBs 1-05 1-10, 1-15 and 1-20 correspond to existing Node Bs of the universal mobile telecommunication system (UMTS). The ENB 1-05, 1-10, 1-15 or 1-20 is connected to the UE 1-35 through a radio channel, but performs more complex functions in comparison to the existing Node B. In the LTE system, all user traffic including real-time services like VoIP (Voice over IP) may be served through shared channels. Hence, an apparatus may be needed to perform scheduling on the basis of collected status information regarding buffers, available transmit powers and channels of the UEs, and the ENBs 1-05, 1-10, 1-15 and 1-20 may be responsible for this. One ENB may control multiple cells in a typical situation. To achieve a data rate of, for example, 100 Mbps in a bandwidth of, for example, 20 MHz, the LTE system may utilize orthogonal frequency division multiplexing (OFDM) as radio access technology. Also, the ENB may apply adaptive modulation and coding (referred to as AMC) to determine the modulation scheme and channel coding rate according to channel states of the UE. The S-GW 1-30 is an entity providing data bearers, and may create and remove data bearers under the control of the MME 1-25. The MME 1-25 is an entity in charge of various control functions including a mobility management function for the UE 1-35, and may be connected to a plurality of ENBs.

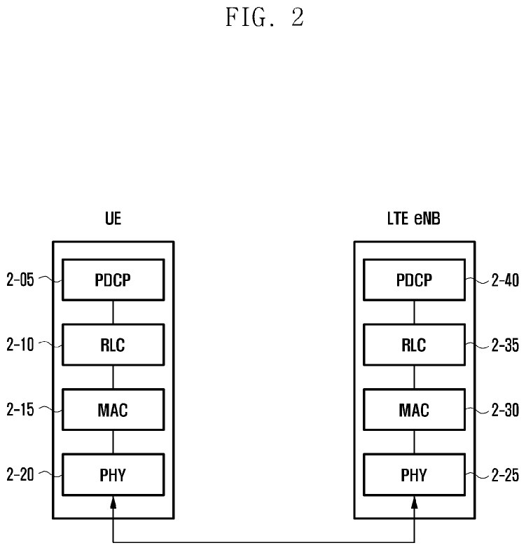

FIG. 2 is a diagram illustrating the structure of radio protocols in an LTE system according to an embodiment of the disclosure.

With reference to FIG. 2, in a UE or an ENB, the radio protocols of the LTE system may include packet data convergence protocol (PDCP) 2-05 or 2-40, radio link control (RLC) 2-10 or 2-35, and medium access control (MAC) 2-15 or 2-30. The PDCP (packet data convergence protocol) 2-05 or 2-40 may perform compression and decompression of IP headers. The main functions of the PDCP may be summarized as follows.
Header compression and decompression function (header compression and decompression: ROHC only)
User data transfer function (transfer of user data)
In-sequence delivery function (in-sequence delivery of upper layer PDUs at PDCP re-establishment procedure for RLC AM)
Reordering function (for split bearers in DC (only support for RLC AM): PDCP PDU routing for transmission and PDCP PDU reordering for reception)
Duplicate detection function (duplicate detection of lower layer SDUs at PDCP re-establishment procedure for RLC AM)
Retransmission function (retransmission of PDCP SDUs at handover and, for split bearers in DC, of PDCP PDUs at PDCP data-recovery procedure, for RLC AM)
Cipher and decipher function (ciphering and deciphering)
Timer-based SDU discard function (timer-based SDU discard in uplink)

The radio link control (referred to as RLC) 2-10 or 2-35 may reconfigure PDCP PDUs (packet data unit) to a suitable size and perform automatic repeat request (ARQ) operation. The main functions of the RLC may be summarized as follows.
Data transfer function (transfer of upper layer PDUs)
ARQ function (error correction through ARQ (only for AM data transfer))
Concatenation, segmentation and reassembly function (concatenation, segmentation and reassembly of RLC SDUs (only for UM and AM data transfer))
Re-segmentation function (re-segmentation of RLC data PDUs (only for AM data transfer))
Reordering function (reordering of RLC data PDUs (only for UM and AM data transfer))
Duplicate detection function (duplicate detection (only for UM and AM data transfer))
Error detection function (protocol error detection (only for AM data transfer))
RLC SDU discard function (RLC SDU discard (only for UM and AM data transfer))
RLC re-establishment function (RLC re-establishment)

The MAC 2-15 or 2-30 may be connected with multiple RLC entities in a UE, and it may multiplex RLC PDUs into MAC PDUs and demultiplex MAC PDUs into RLC PDUs. The main functions of the MAC may be summarized as follows.
Mapping function (mapping between logical channels and transport channels)
Multiplexing and demultiplexing function (multiplexing/demultiplexing of MAC SDUs belonging to one or different logical channels into/from transport blocks (TB) delivered to/from the physical layer on transport channels)
Scheduling information reporting function (scheduling information reporting)
HARQ function (error correction through HARQ)
Priority handling function between logical channels (priority handling between logical channels of one UE)
Priority handling function between UEs (priority handling between UEs by means of dynamic scheduling)
MBMS service identification function (MBMS service identification)
Transport format selection function (transport format selection)
Padding function (padding)

The physical (PHY) layer 2-20 or 2-25 may convert higher layer data into OFDM symbols by means of channel coding and modulation and transmits the OFDM symbols through a radio channel, or it may demodulate OFDM symbols received through a radio channel, perform channel decoding, and forward the result to an upper layer.

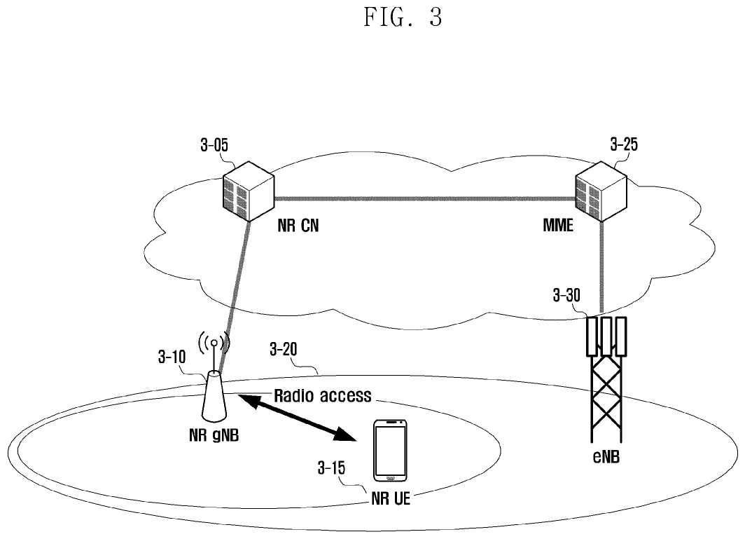

FIG. 3 is a diagram illustrating the architecture of a next-generation mobile communication system according to an embodiment of the disclosure.

With reference to FIG. 3, as shown, the radio access network of a next-generation mobile communication system (hereinafter, NR or 5g) may be composed of a new radio node B (hereinafter, NR gNB or NR base station) 3-10 and a new radio core network (NR CN) 3-05. A new radio user equipment (hereinafter, NR UE or terminal) 3-15 may connect to an external network through the NR gNB 3-10 and the NR CN 3-05.

In FIG. 3, the NR gNB 3-10 may correspond to an evolved node B (eNB) of the existing LTE system. The NR gNB 3-10 may be connected to the NR UE 3-15 through a radio channel, and it can provide a more superior service than that of the existing node B. All user traffic may be serviced through shared channels in the next-generation mobile communication system. Hence, there may be a need for an entity that performs scheduling by collecting status information, such as buffer states, available transmission power states, and channel states of individual UEs, and the NR gNB 3-10 may take charge of this. One NR gNB 3-10 controls a plurality of cells in typical situations. To implement ultra-high-speed data transmission compared with current LTE, a bandwidth beyond the existing maximum bandwidth may be utilized. Also, a beamforming technology may be additionally used with orthogonal frequency division multiplexing (OFDM) serving as a radio access technology. Further, an adaptive modulation and coding (AMC) scheme determining a modulation scheme and channel coding rate to match the channel state of the UE may be applied. The NR CN 3-05 may perform functions such as mobility support, bearer configuration, and quality of service (QoS) configuration. The NR CN 3-05 is an entity taking charge of not only mobility management but also various control functions for the UE 3-15, and may be connected to a plurality of base stations. In addition, the next-generation mobile communication system may interwork with the existing LTE system, and the NR CN 3-05 may be connected to the MME 3-25 through a network interface. The MME 3-25 is connected to an eNB 3-30 being an existing base station.

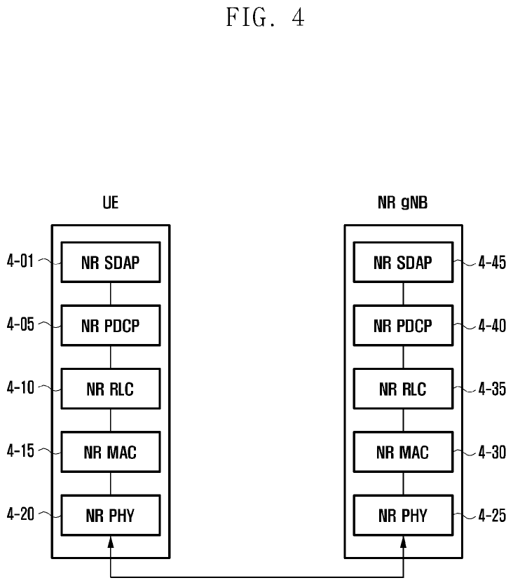

FIG. 4 is a diagram illustrating the structure of radio protocols in a next-generation mobile communication system according to an embodiment of the disclosure.

FIG. 4 is a diagram illustrating a radio protocol structure of a next-generation mobile communication system to which the disclosure may be applied.

With reference to FIG. 4, in a UE or an NR gNB, the radio protocols of the next-generation mobile communication system may include NR SDAP 4-01 or 4-45, NR PDCP 4-05 or 4-40, NR RLC 4-10 or 4-35, and NR MAC 4-15 or 4-30.

The main functions of the NR SDAP 4-01 or 4-45 may include some of the following functions.
User data transfer function (transfer of user plane data)
Mapping function between QoS flows and data bearers for uplink and downlink (mapping between a QoS flow and a DRB for both DL and UL)
QoS flow ID marking function for uplink and downlink (marking QoS flow ID in both DL packets and UL packets)
Function of mapping reflective QoS flow to data bearer for uplink SDAP PDUs (reflective QoS flow to DRB mapping for the UL SDAP PDUs)

With respect to the SDAP entity, the UE may be configured with, through a RRC message, whether to use a header of the SDAP entity or whether to use a function of the SDAP entity for each PDCP entity, bearer, or logical channel. Also, if a SDAP header is configured, a NAS reflective QoS 1-bit indication and AS reflective QoS 1-bit indication of the SDAP header may instruct the UE to update or reconfigure the mapping information between QoS flows and data bearers for the uplink and downlink. The SDAP header may include QoS flow ID information indicating the QoS. The QoS information may be used as data processing priority and scheduling information for supporting smooth services.

The main function of the NR PDCP 4-05 or 4-40 may include some of the following functions.
Header compression and decompression function (header compression and decompression: ROHC only)
User data transfer function (transfer of user data)
In-sequence delivery function (in-sequence delivery of upper layer PDUs)
Out-of-sequence delivery function (out-of-sequence delivery of upper layer PDUs)
Reordering function (PDCP PDU reordering for reception)
Duplicate detection function (duplicate detection of lower layer SDUs)
Retransmission function (retransmission of PDCP SDUs)
Cipher and decipher function (ciphering and deciphering)
Timer-based SDU discard function (timer-based SDU discard in uplink)

In the above description, the reordering function of the NR PDCP entity may indicate reordering of PDCP PDUs received from a lower layer in order based on the PDCP sequence number (SN), and may include delivering data to an upper layer in reordered sequence, directly delivering data without considering the order, recording lost PDCP PDUs through reordering, reporting the status of lost PDCP PDUs to the transmitting side, or requesting retransmission of the lost PDCP PDUs.

The main function of the NR RLC 4-10 or 4-35 may include some of the following functions.
Data transfer function (transfer of upper layer PDUs)
In-sequence delivery function (in-sequence delivery of upper layer PDUs)
Out-of-sequence delivery function (out-of-sequence delivery of upper layer PDUs)
ARQ function (error correction through ARQ)
Concatenation, segmentation and reassembly function (concatenation, segmentation and reassembly of RLC SDUs)
Re-segmentation function (re-segmentation of RLC data PDUs)
Reordering function (reordering of RLC data PDUs)
Duplicate detection function (duplicate detection)
Error detection function (protocol error detection)
RLC SDU discard function (RLC SDU discard)
RLC re-establishment function (RLC re-establishment)

In the above description, in-sequence delivery of the NR RLC entity may indicate in-sequence delivery of RLC SDUs received from a lower layer to an upper layer, and may include: reassembly and delivery of RLC SDUs when several RLC SDUs belonging to one original RLC SDU are received after segmentation; reordering of received RLC PDUs based on the RLC sequence number (SN) or the PDCP SN; recording lost RLC PDUs through reordering; reporting the status of the lost RLC PDUs to the transmitting side; and requesting retransmission of the lost RLC PDUs. If there is a lost RLC SDU, in-sequence delivery of the NR RLC entity may include in-sequence delivery of only RLC SDUs before the lost RLC SDU to an upper layer; or, although there is a lost RLC SDU, if a specified timer has expired, in-sequence delivery thereof may include in-sequence delivery of all the RLC SDUs received before the starting of the timer to an upper layer; or, although there is a lost RLC SDU, if a specified timer has expired, in-sequence delivery thereof may include in-sequence delivery of all the RLC SDUs received up to now to an upper layer. In addition, the NR RLC entity may process RLC PDUs in the order of reception regardless of the order of the sequence number, and transfer them to the NR PDCP entity in an out-of-sequence delivery manner. In case of receiving a segment, the NR RLC entity may reconstruct one whole RLC PDU from segments stored in the buffer or received later, and transfer it to the NR PDCP entity. The NR RLC layer may not include a concatenation function, which may be performed by the NR MAC layer or may be replaced with a multiplexing function of the NR MAC layer.

In the above description, out-of-sequence delivery of the NR RLC entity may indicate a function of transferring RLC SDUs received from a lower layer directly to a higher layer regardless of their order. If several RLC SDUs belonging to one original RLC SDU are received after segmentation, out-of-sequence delivery of the NR RLC entity may include reassembly and delivery of the RLC SDUs. Out-of-sequence delivery thereof may include storing the RLC SNs or PDCP SNs of received RLC PDUs and ordering them to record lost RLC PDUs.

The NR MAC 4-15 or 4-30 may be connected to several NR RLC entities configured in one UE, and the main function of the NR MAC may include some of the following functions.
Mapping function (mapping between logical channels and transport channels)
Multiplexing and demultiplexing function (multiplexing/demultiplexing of MAC SDUs)
Scheduling information reporting function (scheduling information reporting)
HARQ function (error correction through HARQ)
Priority handling function between logical channels (priority handling between logical channels of one UE)
Priority handling function between UEs (priority handling between UEs by means of dynamic scheduling)
MBMS service identification function (MBMS service identification)
Transport format selection function (transport format selection)
Padding function (padding)

The NR PHY 4-20 or 4-25 may compose OFDM symbols from higher layer data through channel coding and modulation and transmit them through a radio channel, or may demodulate and channel-decode OFDM symbols received through a radio channel and forward the result to a higher layer.

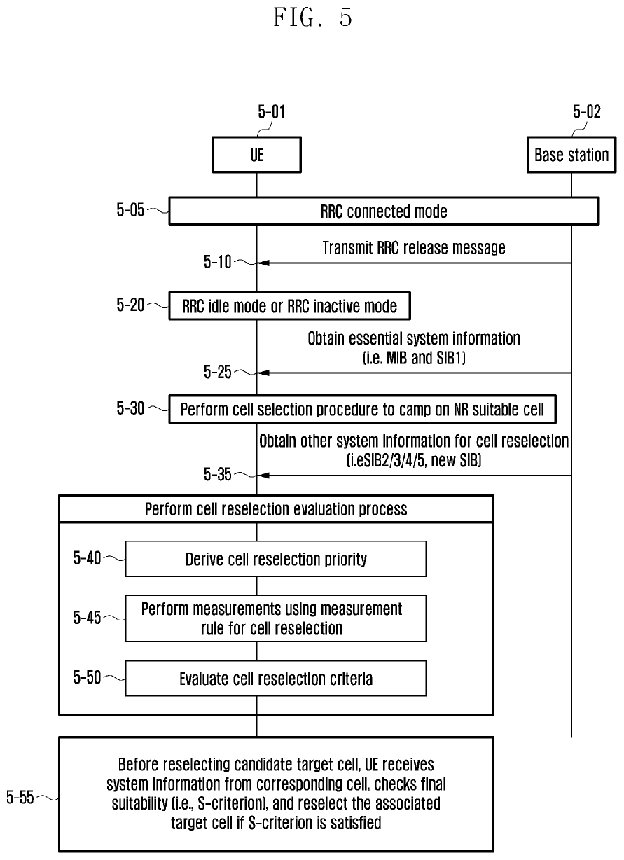

FIG. 5 is a diagram depicting a cell reselection procedure performed by a UE in a next-generation mobile communication system according to an embodiment of the disclosure.

With reference to FIG. 5, the UE 5-01 may establish an RRC connection with an NR base station 5-02 and remain in RRC connected mode (RRC_CONNECTED) (5-05).

At step 5-10, the NR base station 5-02 may transmit an RRC Release message to the UE 5-01. The RRC Release message may be a message indicating release of the RRC connection.

Upon receiving the RRC Release message, at step 5-20, the UE 5-01 may transition to RRC idle mode or RRC inactive mode. Specifically, if receiving an RRC Release message including suspend Config information, the UE 5-01 may transition to RRC inactive mode, otherwise it may transition to RRC idle mode.

At step 5-25, the UE 5-01 in RRC idle mode or RRC inactive mode may obtain essential system information. Essential system information may refer to Master Information Block (MIB) and System Information Block 1 (SIB1).

At step 5-30, the UE 5-01 in RRC idle mode or RRC inactive mode may perform a cell selection procedure to camp on an NR suitable cell. The cell on which the UE 5-01 has camped may be called a serving cell.

In this disclosure, a suitable cell may be defined if the conditions in Table 1 below are satisfied based on 3GPP standard document “38.304: User Equipment (UE) procedures in Idle mode and RRC Inactive state”.

TABLE 1
suitable cell:
For UE not operating in SNPN Access Mode, a cell is considered as suitable if the following
conditions are fulfilled:
-The cell is part of either the selected PLMN or the registered PLMN or PLMN of the Equivalent
PLMN list, and for that PLMN either:
-The PLMN-ID of that PLMN is broadcast by the cell with no associated CAG-IDs and CAG-
only indication in the UE for that PLMN (TS 23.501 [10]) is absent or false;
-Allowed CAG list in the UE for that PLMN (TS 23.501 [10]) includes a CAG-ID broadcast by
the cell for that PLMN;
-The cell selection criteria are fulfilled, see clause 5.2.3.2.
According to the latest information provided by NAS:
-The cell is not barred, see clause 5.3.1;
-The cell is part of at least one TA that is not part of the list of “Forbidden Tracking Areas for
Roaming” (TS 22.011 [18]), which belongs to a PLMN that fulfils the first bullet above.
For UE operating in SNPN Access Mode, a cell is considered as suitable if the following
conditions are fulfilled:
-The cell is part of either the selected SNPN or the registered SNPN of the UE;
-The cell selection criteria are fulfilled, see clause 5.2.3.2;
According to the latest information provided by NAS:
-The cell is not barred, see clause 5.3.1;
-The cell is part of at least one TA that is not part of the list of “Forbidden Tracking Areas for
Roaming” which belongs to either the selected SNPN or the registered SNPN of the UE.

For reference, the UE 5-01 may determine that the cell selection criteria are fulfilled if Equation 1 below is satisfied.

$$Srxlev > 0 AND Squal > 0 \qquad [ Equation 1 ]$$

$$where$$

$$Srxlev = {Q}_{rxlevmeas} - ( {Q}_{rxlevmin} + {Q}_{rxlevminoffset} ) - {P}_{compensation} - {Qoffset}_{temp ,}$$

$$Squal = {Q}_{qualmeas} - ( {Q}_{qualmin} + {Q}_{qualminoffset} ) - {Qoffset}_{temp .}$$

For the definitions of the parameters used here, refer to 3GPP standard document “38.304: User Equipment (UE) procedures in Idle mode and RRC Inactive state”.

At step 5-35, the UE 5-01 in RRC idle mode or RRC inactive mode may obtain system information (e.g., SIB2, SIB3, SIB4, SIB5) containing cell reselection information from the serving cell 5-02 to perform a cell reselection evaluation procedure. SIB2 may include information/parameters commonly applied to the UE for reselecting NR intra-frequency, NR inter-frequency, and inter-RAT frequency cells, and NR intra-frequency cell reselection information excluding information related to NR intra-frequency neighbor cells. For example, SIB2 may include one cell reselection priority configuration information for the serving NR frequency (the frequency to which the currently camped-on cell belongs). The cell reselection priority configuration information may refer to cellReselectionPriority and cellReselectionSubPriority. Specifically, cellReselectionPriority may have an integer value (e.g., integer value in the range of 0 to 7), and cellReselectionSubPriority may have a decimal value (e.g., one decimal value among 0.2, 0.4, 0.6, 0.8). If both cellReselectionPriority and cellReselectionSubPriority are signaled, the UE may derive the cell reselection priority value by adding these two values. For reference, a larger cell reselection priority value means a higher priority. Specifically, the cell reselection configuration information broadcast in SIB2 may be as shown in Table 2 below.

TABLE 2

| | |
|---|---|
| SIB2 ::= | SEQUENCE { |
| cellReselectionInfoCommon | SEQUENCE { |

| | |
|---|---|
| nrofSS-BlocksToAverage | INTEGER (2..maxNrofSS-BlocksToAverage) |

OPTIONAL, -- Need S

| | |
|---|---|
| absThreshSS-BlocksConsolidation | ThresholdNR |

OPTIONAL, -- Need S

| | |
|---|---|
| rangeToBestCell | RangeToBestCell |

OPTIONAL, -- Need R

| | |
|---|---|
| q-Hyst | ENUMERATED { |
| | dB0, dB1, dB2, dB3, dB4, dB5, B6, dB8, dB10, |
| | dB12, dB14, dB16, dB18, dB20, dB22, dB24}, |
| speedStateReselectionPars | SEQUENCE { |
| mobilityStateParameters | MobilityStateParameters, |
| q-HystSF | SEQUENCE { |
| sf-Medium | ENUMERATED {dB-6, dB-4, dB-2, dB0}, |
| sf-High | ENUMERATED {dB-6, dB-4, dB-2, dB0} |

```
      }
    }
OPTIONAL, -- Need R
  ...
  },
```

| | |
|---|---|
| cellReselectionServingFreqInfo | SEQUENCE { |

| | |
|---|---|
| s-NonIntraSearchP | ReselectionThreshold |

OPTIONAL, -- Need S

| | |
|---|---|
| s-NonIntraSearchQ | ReselectionThresholdQ |

OPTIONAL, -- Need S

| | |
|---|---|
| threshServingLowP | ReselectionThreshold, |

| | |
|---|---|
| threshServingLowQ | ReselectionThresholdQ |

OPTIONAL, -- Need R

| cellReselectionPriority | CellReselectionPriority, | |
|---|---|---|
| cellReselectionSubPriority | CellReselectionSubPriority | OPTIONAL, |

```
-- Need R
    ...
  },
```

| | |
|---|---|
| intraFreqCellReselectionInfo | SEQUENCE { |
| q-RxLevMin | Q-RxLevMin, |

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| s-IntraSearchP | ReselectionThreshold, |

| | |
|---|---|
| s-IntraSearchQ | ReselectionThresholdQ |

OPTIONAL, -- Need S

| | |
|---|---|
| t-ReselectionNR | T-Reselection, |

| | |
|---|---|
| frequencyBandList | MultiFrequencyBandListNR-SIB |

OPTIONAL, -- Need S

| | |
|---|---|
| frequencyBandListSUL | MultiFrequencyBandListNR-SIB |

OPTIONAL, -- Need R

| | |
|---|---|
| p-Max | P-Max |

OPTIONAL, -- Need S

| | |
|---|---|
| smtc | SSB-MTC |

OPTIONAL, -- Need S

| | |
|---|---|
| ss-RSSI-Measurement | SS-RSSI-Measurement |

OPTIONAL, -- Need R

| | |
|---|---|
| ssb-ToMeasure | SSB-ToMeasure |

OPTIONAL, -- Need S

| | |
|---|---|
| deriveSSB-IndexFromCell | BOOLEAN, |

```
    ...,
    [[
```

| | |
|---|---|
| t-ReselectionNR-SF | SpeedStateScaleFactors |

```
OPTIONAL -- Need N
    ]],
    [[
```

| | |
|---|---|
| smtc2-LP-r16 | SSB-MTC2-LP-r16 |

OPTIONAL, -- Need R

| | |
|---|---|
| ssb-PositionQCL-Common-r16 | SSB-PositionQCL-Relation-r16 |

```
OPTIONAL -- Cond SharedSpectrum
    ]]
  },
  ...,
  [[
```

| | |
|---|---|
| relaxedMeasurement-r16 | SEQUENCE { |
| lowMobilityEvaluation-r16 | SEQUENCE { |
| s-SearchDeltaP-r16 | ENUMERATED { |
| | dB3, dB6, dB9, dB12, dB15, |
| | spare3, spare2, spare1}, |
| t-SearchDeltaP-r16 | ENUMERATED { |
| | s5, s10, s20, s30, s60, s120, s180, |
| | s240, s300, spare7, spare6, spare5, |
| | spare4, spare3, spare2, spare1} |

}
OPTIONAL, -- Need R

| | |
|---|---|
| cellEdgeEvaluation-r16 | SEQUENCE { |
| s-SearchThresholdP-r16 | ReselectionThreshold, |

| | |
|---|---|
| s-SearchThresholdQ-r16 | ReselectionThresholdQ |

OPTIONAL -- Need R
}
OPTIONAL, -- Need R

| | |
|---|---|
| combineRelaxedMeasCondition-r16 | ENUMERATED {true} |

OPTIONAL, -- Need R

| | |
|---|---|
| highPriorityMeasRelax-r16 | ENUMERATED {true} |

```
OPTIONAL -- Need R
  }
OPTIONAL -- Need R
  ]]
}
RangeToBestCell ::= Q-OffsetRange
```

SIB3 may include neighbor cell information/parameters for the UE 5-01 to reselect an NR intra-frequency cell. For example, SIB3 may broadcast an NR intra-frequency cell list (intraFreqNeighCellList) for reselecting NR intra-frequency cells or a cell list (intraFreqBlackCellList) for which NR intra-frequency cell reselection is not allowed. Specifically, SIB3 may broadcast the information in Table 3 below.

TABLE 3

| | |
|---|---|
| SIB3 ::= | SEQUENCE { |

| | |
|---|---|
| intraFreqNeighCellList | IntraFreqNeighCellList |

OPTIONAL, -- Need R

| | |
|---|---|
| intraFreqBlackCellList | IntraFreqBlackCellList |

OPTIONAL, -- Need R

| | |
|---|---|
| lateNonCriticalExtension | OCTET STRING |

```
OPTIONAL,
  ...,
  [[
```

| | |
|---|---|
| intraFreqNeighCellList-v1610 | IntraFreqNeighCellList-v1610 |

OPTIONAL, -- Need R

| | |
|---|---|
| intraFreqWhiteCellList-r16 | IntraFreqWhiteCellList-r16 |

OPTIONAL, -- Cond SharedSpectrum2

| | |
|---|---|
| intraFreqCAG-CellList-r16 | SEQUENCE (SIZE (1..maxPLMN)) OF |
| | IntraFreqCAG-CellListPerPLMN-r16 |

OPTIONAL -- Need R
]]
}

| IntraFreqNeighCellList ::= | SEQUENCE (SIZE (1..maxCellIntra)) OF IntraFreqNeighCellInfo | |
|---|---|---|
| IntraFreqNeighCellList-v1610::= | SEQUENCE (SIZE (1..maxCellIntra)) OF IntraFreqNeighCellInfo-v1610 | |
| IntraFreqNeighCellInfo ::= | SEQUENCE { | |
| physCellId | PhysCellId, | |
| q-OffsetCell | Q-OffsetRange, | |
| q-RxLevMinOffsetCell | INTEGER (1..8) | OPTIONAL, -- |

Need R

| | | |
|---|---|---|
| q-RxLevMinOffsetCellSUL | INTEGER (1..8) | OPTIONAL, - |

- Need R

| | | |
|---|---|---|
| q-QualMinOffsetCell | INTEGER (1..8) | OPTIONAL, -- |

Need R
...
}

| IntraFreqNeighCellInfo-v1610 ::= | SEQUENCE { | |
|---|---|---|
| ssb-PositionQCL-r16 | SSB-PositionQCL-Relation-r16 | OPTIONAL -- |

Cond SharedSpectrum2
}

| | |
|---|---|
| IntraFreqBlackCellList ::= | SEQUENCE (SIZE (1..maxCellBlack)) OF PCI-Range |
| IntraFreqWhiteCellList-r16 ::= | SEQUENCE (SIZE (1..maxCellWhite)) OF PCI-Range |

IntraFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell-r16)) OF PCI-Range |

}

SIB4 may include information/parameters for the UE 5-01 to reselect an NR inter-frequency cell. For example, SIB4 may broadcast one or multiple NR inter-frequencies, and may include one cell reselection priority configuration information for each NR inter-frequency. The cell reselection priority configuration information for each NR inter-frequency refers to the contents described above (e.g., cellReselectionPriority and/or cellReselectionSubPriority mapped to each NR inter-frequency), but has the characteristic that one cell reselection priority configuration information for each inter-frequency is optionally broadcast. Specifically, the information in Table 4 below may be broadcasted in SIB4.

TABLE 4

| SIB4 ::= | SEQUENCE { | |
|---|---|---|
| interFreqCarrierFreqList | InterFreqCarrierFreqList, | |
| lateNonCriticalExtension | OCTET STRING | OPTIONAL, |

```
  ...,
  [[
```

| | | |
|---|---|---|
| interFreqCarrierFreqList-v1610 | InterFreqCarrierFreqList-v1610 | OPTIONAL -- Need R |

]]
}

| | |
|---|---|
| InterFreqCarrierFreqList ::= | SEQUENCE (SIZE (1..maxFreq)) OF InterFreqCarrierFreqInfo |
| InterFreqCarrierFreqList-v1610 ::= | SEQUENCE (SIZE (1..maxFreq)) OF InterFreqCarrierFreqInfo-v1610 |
| InterFreqCarrierFreqInfo ::= | SEQUENCE { |
| dl-CarrierFreq | ARFCN-ValueNR, |

| | |
|---|---|
| frequencyBandList | MultiFrequencyBandListNR-SIB |

OPTIONAL, -- Cond Mandatory

| | |
|---|---|
| frequencyBandListSUL | MultiFrequencyBandListNR-SIB |

OPTIONAL, -- Need R

| | |
|---|---|
| nrofSS-BlocksToAverage | (INTEGER (2..maxNrofSS-BlocksToAverage) |

OPTIONAL, -- Need S

| | |
|---|---|
| absThreshSS-BlocksConsolidation | ThresholdNR |

OPTIONAL, -- Need S

| | |
|---|---|
| smtc | SSB-MTC |

OPTIONAL, -- Need S

| | |
|---|---|
| ssbSubcarrierSpacing | SubcarrierSpacing, |

| | |
|---|---|
| ssb-ToMeasure | SSB-ToMeasure |

OPTIONAL, -- Need S

| | |
|---|---|
| deriveSSB-IndexFromCell | BOOLEAN, |

| | |
|---|---|
| ss-RSSI-Measurement | SS-RSSI-Measurement |

OPTIONAL,

| | |
|---|---|
| q-RxLevMin | Q-RxLevMin, |

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| p-Max | P-Max |

OPTIONAL, -- Need S

| | |
|---|---|
| t-ReselectionNR | T-Reselection, |

| | |
|---|---|
| t-ReselectionNR-SF | SpeedStateScaleFactors |

OPTIONAL, -- Need S

| | |
|---|---|
| threshX-HighP | ReselectionThreshold, |
| threshX-LowP | ReselectionThreshold, |
| threshX-Q | SEQUENCE { |
| threshX-HighQ | ReselectionThresholdQ, |
| threshX-LowQ | ReselectionThresholdQ |

}
OPTIONAL, -- Cond RSRQ

| | | |
|---|---|---|
| cellReselectionPriority | CellReselectionPriority | OPTIONAL, |

-- Need R

| | | |
|---|---|---|
| cellReselectionSubPriority | CellReselectionSubPriority | OPTIONAL, |

-- Need R

| | |
|---|---|
| q-OffsetFreq | Q-OffsetRange |

DEFAULT dB0,

| | | |
|---|---|---|
| interFreqNeighCellList | InterFreqNeighCellList | OPTIONAL, |

-- Need R

| | | |
|---|---|---|
| interFreqBlackCellList | InterFreqBlackCellList | OPTIONAL, |

-- Need R
...
}
InterFreqCarrierFreqInfo-v1610 ::= SEQUENCE {

| | | |
|---|---|---|
| interFreqNeighCellList-v1610 | InterFreqNeighCellList-v1610 | OPTIONAL, |

-- Need R

| | |
|---|---|
| smtc2-LP-r16 | SSB-MTC2-LP-r16 |

OPTIONAL, -- Need R

| | | |
|---|---|---|
| interFreqWhiteCellList-r16 | InterFreqWhiteCellList-r16 | OPTIONAL, |

-- Cond SharedSpectrum2

| | |
|---|---|
| ssb-PositionQCL-Common-r16 | SSB-PositionQCL-Relation-r16 |

OPTIONAL, -- Cond SharedSpectrum

| | |
|---|---|
| interFreqCAG-CellList-r16 | SEQUENCE (SIZE (1..maxPLMN)) OF |
| | InterFreqCAG-CellListPerPLMN-r16 |

OPTIONAL -- Need R
}

| | |
|---|---|
| InterFreqNeighCellList ::= | SEQUENCE (SIZE (1..maxCellInter)) OF InterFreqNeighCellInfo |
| InterFreqNeighCellList-v1610 ::= | SEQUENCE (SIZE (1..maxCellInter)) OF InterFreqNeighCellInfo-v1610 |
| InterFreqNeighCellInfo ::= | SEQUENCE { |
| physCellId | PhysCellId, |
| q-OffsetCell | Q-OffsetRange, |

| | |
|---|---|
| q-RxLevMinOffsetCell | INTEGER (1..8) |

OPTIONAL, -- Need R

| | |
|---|---|
| q-RxLexMinOffsetCellSUL | INTEGER (1..8) |

OPTIONAL, -- Need R

| | |
|---|---|
| q-QualMinOffsetCell | INTEGER (1..8) |

OPTIONAL, -- Need R
...
}

| | |
|---|---|
| InterFreqNeighCellInfo-v1610 ::= | SEQUENCE { |

| | |
|---|---|
| ssb-PositionQCL-r16 | SSB-PositionQCL-Relation-r16 |

OPTIONAL -- Cond SharedSpectrum2
}

| | |
|---|---|
| InterFreqBlackCellList ::= | SEQUENCE (SIZE (1..maxCellBlack)) OF PCI-Range |
| InterFreqWhiteCellList-r16 ::= | SEQUENCE (SIZE (1..maxCellWhite)) OF PCI-Range |

InterFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell-r16)) OF PCI-Range |

}

SIB5 may include information/parameters for the UE to reselect an inter-RAT frequency cell. For example, SIB5 may broadcast one or multiple EUTRA frequencies, and may include one cell reselection priority configuration information for each EUTRA frequency. The cell reselection priority configuration information for each EUTRA frequency may refer to the contents described above (e.g., cellReselectionPriority and/or cellReselectionSubPriority mapped to each EUTRA frequency), but has the characteristic that one cell reselection priority configuration information for each EUTRA frequency is optionally broadcast. Specifically, the information in Table 5 below may be broadcasted in SIB5.

TABLE 5

| | |
|---|---|
| SIB5 ::= | SEQUENCE { |

| | |
|---|---|
| carrierFreqListEUTRA | CarrierFreqListEUTRA |

OPTIONAL, -- Need R

| | |
|---|---|
| t-ReselectionEUTRA | T-Reselection, |

| | |
|---|---|
| t-ReselectionEUTRA-SF | SpeedStateScaleFactors |

OPTIONAL, -- Need S

| | |
|---|---|
| lateNonCriticalExtension | OCTET STRING |

```
OPTIONAL,
  ...,
  [[
```

| | |
|---|---|
| carrierFreqListEUTRA-v1610 | CarrierFreqListEUTRA-v1610 |

OPTIONAL -- Need R
]]
}

| | |
|---|---|
| CarrierFreqListEUTRA ::= | SEQUENCE (SIZE (1..maxEUTRA-Carrier)) OF |

CarrierFreqEUTRA

| | |
|---|---|
| CarrierFreqListEUTRA-v1610 ::= | SEQUENCE (SIZE (1..maxEUTRA-Carrier)) OF |

CarrierFreqEUTRA-v1610

| | |
|---|---|
| CarrierFreqEUTRA ::= | SEQUENCE { |
| carrierFreq | ARFCN-ValueEUTRA, |

| | |
|---|---|
| eutra-multiBandInfoList | EUTRA-MultiBandInfoList |

OPTIONAL, -- Need R

| | |
|---|---|
| eutra-FreqNeighCellList | EUTRA-FreqNeighCellList |

OPTIONAL, -- Need R

| | |
|---|---|
| eutra-BlackCellList | EUTRA-FreqBlackCellList |

OPTIONAL, -- Need R

| allowedMeasBandwidth | EUTRA-AllowedMeasBandwidth, | |
|---|---|---|
| presenceAntennaPort1 | EUTRA-PresenceAntennaPort1, | |
| cellReselectionPriority | CellReselectionPriority | OPTIONAL, |

-- Need R

| | | |
|---|---|---|
| cellReselectionSubPriority | CellReselectionSubPriority | OPTIONAL, |

-- Need R

| | |
|---|---|
| threshX-High | ReselectionThreshold, |
| threshX-Low | ReselectionThreshold, |
| q-RxLevMin | INTEGER (−70..−22), |
| q-QualMin | INTEGER (−34..−3), |
| p-MaxEUTRA | INTEGER (−30..33), |
| threshX-Q | SEQUENCE { |
| threshX-HighQ | ReselectionThresholdQ, |
| threshX-LowQ | ReselectionThresholdQ |

}
OPTIONAL -- Cond RSRQ
}
CarrierFreqEUTRA-v1610 ::= SEQUENCE {

| | |
|---|---|
| highSpeedEUTRACarrier-r16 | ENUMERATED {true} |

OPTIONAL -- Need R
}

| | |
|---|---|
| EUTRA-FreqBlackCellList ::= | SEQUENCE (SIZE (1..maxEUTRA-CellBlack)) OF EUTRA- |

PhysCellIdRange

| | |
|---|---|
| EUTRA-FreqNeighCellList ::= | SEQUENCE (SIZE (1..maxCellEUTRA)) OF EUTRA- |

FreqNeighCellInfo

| | |
|---|---|
| EUTRA-FreqNeighCellInfo ::= | SEQUENCE { |
| physCellId | EUTRA-PhysCellId, |
| dummy | EUTRA-Q-OffsetRange, |

| | |
|---|---|
| q-RxLevMinOffsetCell | INTEGER (1..8) |

OPTIONAL, -- Need R

| | |
|---|---|
| q-QualMinOffsetCell | INTEGER (1..8) |

OPTIONAL -- Need R
}

The UE 5-01 in RRC idle mode or RRC inactive mode may perform a cell reselection evaluation process. The cell reselection evaluation process may refer to a series of processes for determining reselection priorities (reselection priorities handling), performing frequency measurements by applying measurement rules for cell reselection according to the determined reselection priorities, and evaluating cell reselection criteria accordingly to reselect a cell.

At step 5-40, the UE 5-01 in RRC idle mode or RRC inactive mode may derive the reselection priority based on the system information received at step 5-25. The UE may determine the reselection priority only for the frequency for which the cell reselection priority value is broadcast via the system information. With respect to the cell reselection priority value mapped to the NR frequency to which the serving cell currently camped-on belongs, the UE 5-01 according to the disclosure may determine whether the cell reselection priority for each NR inter-frequency or inter-RAT frequency has the same cell reselection priority as the NR frequency to which the serving cell belongs, has a cell reselection priority higher than the NR frequency to which the serving cell belongs, or has a cell reselection priority lower than the NR frequency to which the serving cell belongs. For example, in the system information obtained at step 5-25, if the cell reselection priority value mapped to the NR frequency to which the serving cell currently camped on is 3, the cell reselection priority value of inter NR frequency 1 is 2, the cell reselection priority value of inter NR frequency 2 is 3, the cell reselection priority value of inter NR frequency 3 is 4, and the cell reselection priority value of EUTRA frequency 1 is 2, the UE 5-01 may determine the cell reselection priority of inter NR frequency 1 and EUTRA frequency 1 as lower reselection priority, determine the cell reselection priority of inter NR frequency 2 as equal reselection priority, and determine the cell reselection priority of inter NR frequency 3 as higher reselection priority.

At step 5-45, the UE 5-01 in RRC idle mode or RRC inactive mode may perform frequency measurement for cell reselection. At this time, to minimize battery consumption, the UE 5-01 may perform frequency measurement according to the cell reselection priority determined at step 5-40 by using the following measurement rule.
The UE 5-01 may not perform NR intra-frequency measurement if condition 1 below is satisfied. Otherwise (e.g., if condition 1 below is not satisfied), the UE 5-01 performs NR intra-frequency measurement.
Condition 1: the reception level (Srxlev) of the serving cell is greater than threshold SIntraSearchP and the reception quality (Squal) of the serving cell is greater than threshold SIntraSearchQ (serving cell fulfils Srxlev>SIntraSearchP and Squal>SIntraSearchQ).
The UE may perform measurements according to the 3GPP TS 38.133 standard for NR inter-frequency or inter-RAT frequency having a higher reselection priority than the NR frequency of the current serving cell.
For an NR inter-frequency having a reselection priority lower than or equal to the NR frequency of the current serving cell and an inter-RAT frequency having a reselection priority lower than the NR frequency of the current serving cell, the UE 5-01 may not perform measurement if condition 2 below is satisfied. Otherwise (e.g., if condition 2 below is not satisfied), the UE measures cells in the NR inter-frequency that has a reselection priority lower than or equal to the NR frequency, or measures cells in the inter-RAT frequency that has a reselection priority lower than the NR frequency.
Condition 2: the reception level (Srxlev) of the serving cell is greater than threshold SnonIntraSearchP and the reception quality (Squal) of the serving cell is greater than threshold SnonIntraSearchQ (serving cell fulfils Srxlev>SnonIntraSearchP and Squal>SnonIntraSearchQ).

For reference, the aforementioned thresholds (SintraSearchP, SintraSearchQ, SnonIntraSearchP SnonintraSearchQ) may be broadcasted via the system information obtained at step 5-25.

At step 5-50, for reselection, the UE 5-01 in RRC idle mode or RRC inactive state may determine a cell satisfying the cell reselection criteria based on the measurement value obtained at step 5-45. The cell reselection criteria may apply different criteria depending on the cell reselection priority. If multiple cells satisfying the cell reselection criteria have different cell reselection priorities, re-selecting a frequency/RAT cell with a higher cell reselection priority shall take precedence over re-selecting a frequency/RAT cell with a lower priority (cell reselection to a higher priority RAT/frequency shall take precede over a lower priority RAT/frequency if multiple cells of different priorities fulfil the cell reselection criteria). Specifically, for the reselection criteria of an inter-frequency/inter-RAT cell with a higher priority than the frequency of the current serving cell, the UE's operation is as follows.

### First Operation:

When threshold threshServingLowQ is broadcast in SIB2 and 1 second has elapsed since the UE 5-01 camped on the current serving cell, if the signal quality (Squal) of an inter-frequency/inter-RAT cell is greater than threshold Thresh_{X,HighQ} during specific time T_{reselectionRAT} (Squal>Thresh_{X,HighQ} during a time interval T_{reselectionRAT}), the UE performs reselection to the corresponding inter-frequency/inter-RAT cell.

### Second Operation:

If the UE 5-01 is unable to perform the first operation, it performs the second operation.
If 1 second has elapsed since the UE 5-01 camped on the current serving cell, and the reception level (Srxlev) of an inter-frequency/inter-RAT cell is greater than threshold Thresh_{X,HighP} during specific time T_{reselectionRAT} (Srxlev>Thresh_{X, HighP} during a time interval T_{reselection-RAT}), the UE 5-01 performs reselection to the corresponding inter-frequency/inter-RAT cell.

Here, the UE 5-01 performs the first operation or the second operation for the inter-frequency cell based on the information contained in SIB4 broadcast from the serving cell, such as signal quality (Squal), reception level (Srxlev), thresholds (Threh_{X, HighQ}, Thresh_{X, HighP}), and T_{reselectionRAT} values, and performs the first or second operation for the inter-RAT cell based on the information contained in SIB5 broadcast from the serving cell, such as signal quality (Squal), reception level (Srxlev), thresholds (Thresh_{X, HighQ}, Thresh_{X, HighP}), and T_{reselectionRAT} values. For example, SIB4 includes Q_{qualmin} value or Qᵣₓₗₑᵥₘᵢₙ value, and the signal quality (Squal) or reception level (Srxlev) of the inter-frequency cell is derived based on this. If there are multiple cells in the NR frequency having a high cell reselection priority, the UE 5-01 may reselect the highest ranked cell among the cells satisfying the reselection criteria of an intra-frequency/inter-frequency cell having the same priority as the frequency of the current serving cell described below.

In addition, the operation of the UE 5-01 for the reselection criteria of the intra-frequency/inter-frequency cell having the same priority as the frequency of the current serving cell is as follows.

### Third Operation:

If signal quality (Squal) and reception level (Srxlev) of the intra-frequency/inter-frequency cell are greater than 0, the cell-specific rank is derived based on the measurement value (RSRP, reference signal received power) (the UE shall perform ranking of all cells that fulfills the cell selection criterion S). The ranks of the serving cell and neighbor cells are calculated using Equation 2 below.

$${R}_{s} = {Q}_{meas , s} + {Q}_{hyst} \qquad [ Equation 2 ]$$

$${R}_{n} = {Q}_{meas , n} - {Q}_{offset}$$

Here, Q_{meas,s} is the RSRP measurement value of the serving cell, Q_{meas,n} is the RSRP measurement value of the neighbor cell, Q_{hyst} is the hysteresis value of the serving cell, and Q_{offset} is the offset between the serving cell and the neighbor cell. SIB2 contains the Q_{hyst} value, which is commonly used for intra-frequency/inter-frequency cell reselection. In the case of intra-frequency cell reselection, Q_{offset} is signaled per cell, applied only to the indicated cell, and included in SIB3. In the case of inter-frequency cell reselection, Q_{offset} is signaled per cell, applied only to the indicated cell, and included in SIB4. In the case where the rank of the neighbor cell obtained from Equation 2 above is greater than the rank of the serving cell (Rn>Rs), reselection is performed to the optimal cell among the neighbor cells.

In addition, the UE's operation for the reselection criteria of an inter-frequency/inter-RAT cell with a lower priority than the frequency of the current serving cell is as follows.

### Fourth Operation:

When threshold threshServingLowQ is broadcast in SIB2 and 1 second has elapsed since the UE 5-01 camped on the current serving cell, if the signal quality (Sqaul) of the current serving cell is lower than threshold Thresh_{Serving, LowQ} (Squal<Thresh_{Serving, LowQ}) and the signal quality (Squal) of an inter-frequency/inter-RAT cell is higher than threshold Thresh_{X, LowQ} during a specific time T_{reseleetionRAT} (Squal>Thresh_{X,LowQ} during a time interval T_{reselectionRAT}), the UE performs reselection to the corresponding inter-frequency/inter-RAT cell.

### Fifth Operation:

If the UE is unable to perform the fourth operation, it performs the fifth operation.
If 1 second has elapsed since the UE camped on the current serving cell, and the reception level (Srxlev) of the current serving cell is lower than threshold Thresh_{Serving, LowP} (Srxlev<Thresh_{Serving, LowP}) and the reception level (Srxlev) of an inter-frequency/inter-RAT cell is higher than threshold Thresh_{X, LowQ} during a specific time T_{reseleetionRAT} (Srxlev>Thresh_{X,LowP} during a time interval T_{reselectionRAT}), the UE 5-01 performs reselection to the corresponding inter-frequency/inter-RAT cell.

The fourth or fifth operation for the inter-frequency cell of the UE 5-01 is performed based on the thresholds (Thresh_{Serving, LowQ}, Thresh_{Serving, LowP}) included in SIB2 broadcasted from the serving cell, and the signal quality (Squal), reception level (Srxlev), thresholds (Threh_{X, LowQ}, Thresh_{X, LowP}), and T_{reseleetionRAT} of the inter-frequency cell included in SIB4 broadcasted from the serving cell. The fourth or fifth operation for the inter-RAT cell of the UE is performed based on the thresholds (Thresh_{Serving, LowQ}, Thresh_{Serving, LowP}) included in SIB2 broadcasted from the serving cell, and the signal quality (Squal), reception level (Srxlev), thresholds (Thresh_{X, LowQ}, Thresh_{X, LowP}), and T_{reselectionRAT} of the inter-RAT cell included in SIB5 broadcasted from the serving cell. For example, SIB4 includes Q_{qualmin} value or Qᵣₓₗₑᵥₘᵢₙ value, and the UE 5-01 may derive the signal quality (Squal) or reception level (Srxlev) of the inter-frequency cell based on this. If there are multiple cells in the NR frequency satisfying a high cell reselection priority, the terminal 5-01 may reselect the highest ranked cell among the cells satisfying the reselection criteria of the intra-frequency/inter-frequency cell having the same priority as the frequency of the current serving cell described below. Here, if one candidate cell satisfying the above-mentioned conditions is derived from among the frequencies having a higher or lower priority than the frequency of the current serving cell, the UE 5-01 may reselect the derived candidate cell as the best cell (strongest cell).

At step 5-55, before finally reselecting a candidate target cell, the UE 5-01 in RRC idle mode or RRC inactive state receives system information (e.g., MIB or SIB1) broadcasted by the candidate target cell, and determines whether the reception level (Srxlev) and reception quality (Squal) of the candidate target cell satisfy the cell selection criterion (Srxlev>0 AND Squal>0) called S-criterion (Equation 1) based on the received system information. The UE 5-01 may reselect the candidate target cell if Equation 1 is satisfied and the candidate target cell is suitable.

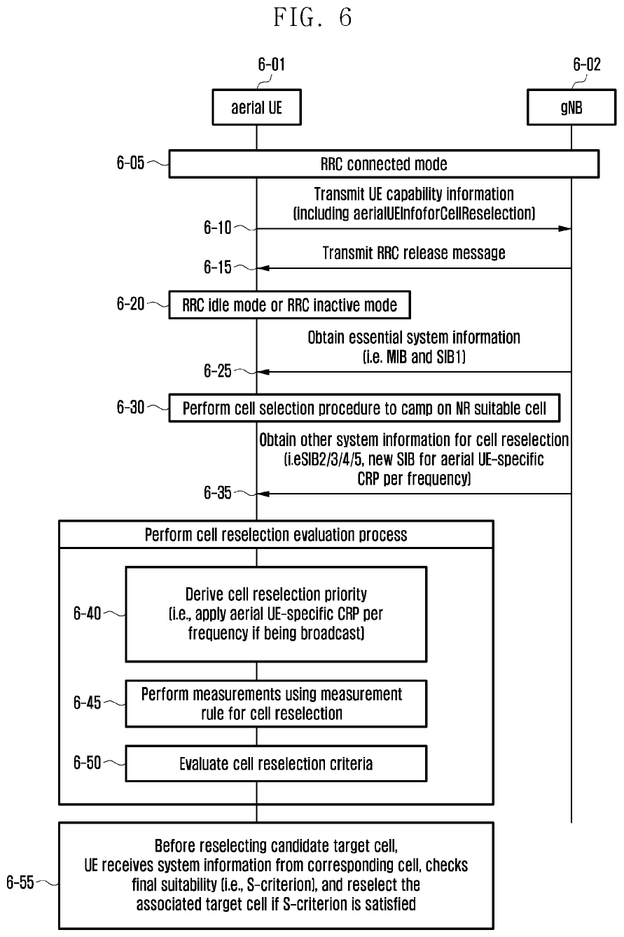

FIG. 6 is a diagram depicting a cell reselection procedure performed by an aerial UE in a next-generation mobile communication system according to an embodiment of the disclosure.

The UE according to an embodiment of the disclosure may be referred to as an aerial UE. For example, an aerial UE may be a UE with uncrewed aerial vehicle (UAV) functionality or may mean a drone. In other words, the aerial UE may receive an UAV service while flying at a specific altitude.

With reference to FIG. 6, the aerial UE 6-01 may establish an RRC connection with the NR base station 6-02 and remain in RRC connected mode (RRC_CONNECTED) (6-05).

At step 6-10, the aerial UE 6-01 may transmit a UE capability information message to the NR base station 6-02. This message may include the following information.
An indicator indicating whether the aerial UE can apply the cell reselection priority for the aerial UE broadcasted in the system information in RRC idle mode (RRC_IDLE) or RRC inactive mode (RRC_INACTIVE). For example, this indicator may be referred to as, but not limited to, aerial UE Info for cell reselection.

At step 6-15, the NR base station 6-02 may transmit an RRC connection release message (RRC Release message) to the aerial UE 6-01.

Upon receiving the RRC Release message, at step 6-20, the aerial UE 6-01 may transition to RRC idle mode or RRC inactive mode. Specifically, when receiving an RRC Release message including suspend Config information, the aerial UE 6-01 may transition to RRC inactive mode, otherwise it may transition to RRC idle mode.

At step 6-25, the aerial UE 6-01 in RRC idle mode or RRC inactive mode may obtain essential system information. The essential system information may indicate Master Information Block (MIB) and System Information Block 1 (SIB1).

At step 6-30, the aerial UE 6-01 in RRC idle mode or RRC inactive mode may perform a cell selection procedure to camp on an NR suitable cell.

At step 6-35, the UE 6-01 in RRC idle mode or RRC inactive mode may obtain system information (e.g., SIB2, SIB3, SIB4, SIB5, new SIB) containing cell reselection information from the serving cell 6-02 to perform a cell reselection evaluation process. It is proposed that the serving cell according to an embodiment of the disclosure broadcasts one or two cell reselection priority (referred to as CRP) values per frequency. Specifically,
At least one of a first CRP (legacy CRP) or a second CRP (CRP for aerial UE) of the serving frequency may be broadcast in SIB2.
At least one of a first CRP (legacy CRP) or a second CRP (CRP for aerial UE) per NR inter-frequency may be broadcast in SIB4.
At least one of a first CRP (legacy CRP) or a second CRP (CRP for aerial UE) per E-UTRAN frequency may be broadcast in SIB5.
If no second CRP (CRP for aerial UE) is broadcast in the above system information, a second CRP (CRP for aerial UE) per frequency may be broadcast in new SIB.

The CRP may indicate at least one of a cell reselection priority IE (information element) or a cell reselection subpriority IE. As in the above-described embodiment, the cell reselection priority IE may store an integer value (e.g., an integer value from 0 to 7), and the cell reselection subpriority IE may store a decimal value (e.g., a decimal value among 0.2, 0.4, 0.6, 0.8). If only one of the two IEs is signaled, the UE 6-01 may derive the cell reselection priority value from the signaled value, and if both IEs are signaled, the UE may derive the cell reselection priority value by adding the two signaled values.

The aerial UE 6-01 in RRC idle mode or RRC inactive mode may perform a cell reselection evaluation process. The cell reselection evaluation process may refer to a series of processes for determining reselection priorities (reselection priorities handling), performing frequency measurements according to the determined reselection priorities by applying measurement rules for cell reselection, and evaluating cell reselection criteria correspondingly to reselect a cell.

At step 6-40, the aerial UE 6-01 in RRC idle mode or RRC inactive mode may derive the reselection priority based on the system information received at step 6-25. The UE 6-01 may determine the reselection priority only for the frequency for which a cell reselection priority value is broadcast in the system information. It is proposed that the UE 6-01 according to the disclosure determines the reselection priority by applying the second CRP if the second CRP is broadcasted for each frequency, or by applying the first CRP for each frequency if not. Specifically, if only the second CRP is broadcast for a specific frequency or both the first CRP and the second CRP are broadcast, the UE 6-01 may apply the second CRP to determine the reselection priority. If only the first CRP is broadcast for a specific frequency, the UE 6-01 may apply it to determine the reselection priority. The method by which the UE 6-01 derives the frequency-specific reselection priority may follow the above-described embodiment. An advantage of the disclosure is that interference of downlink or uplink may be controlled or cell load may be controlled by allowing the aerial UE 6-01 to applying a separate CRP at a specific frequency.

At step 6-45, the aerial UE 6-01 in RRC idle mode or RRC inactive mode may perform frequency measurement for cell reselection. At this time, to minimize battery consumption, the UE 6-01 may perform frequency measurement according to the cell reselection priority determined at step 6-40 by using the measurement rule of the above-described embodiment. For example, the measurement rule and measurement operation described at step 5-45 may be applied at step 6-45.

At step 6-50, the aerial UE 6-01 in RRC idle mode or RRC inactive state may determine a cell satisfying the cell reselection criteria based on the measurement value obtained at step 6-45 for cell reselection. This may follow the above-described embodiment. For example, the cell reselection operation described at step 5-50 may be applied at step 6-50. For reference, in the disclosure, a list of cells that the aerial UE 6-01 can reselect (e.g., a PCI list for cell reselection for aerial UE) may be broadcast, and only cells belonging to the broadcasted cell list may be reselected. Alternatively, a list of cells that the aerial UE 6-01 cannot reselect may be broadcast, and only cells not belonging to the broadcasted cell list may be reselected. For reference, the parameter applied to Equation 2 (e.g., Q_{offset}) may be separately broadcast in system information, and the UE may apply it to perform ranking of cells (indicating Equation 2).

At step 6-55, before finally reselecting a candidate target cell, the aerial UE 6-01 in RRC idle mode or RRC inactive state receives system information (e.g., MIB or SIB1) broadcasted by the candidate target cell, and determines whether the reception level (Srxlev) and reception quality (Squal) of the candidate target cell satisfy the cell selection criterion called S-criterion (Equation 1) (Srxlev>0 AND Squal>0) based on the received system information. If Equation 1 is satisfied and the candidate target cell is suitable, the UE 6-01 may reselect the candidate target cell.

The configuration identical to the configuration described in the example of FIG. 5 is omitted from the description in the example of FIG. 6, so for the description of the procedure and message corresponding to FIG. 5 in the example of FIG. 6, refer to the description in FIG. 5.

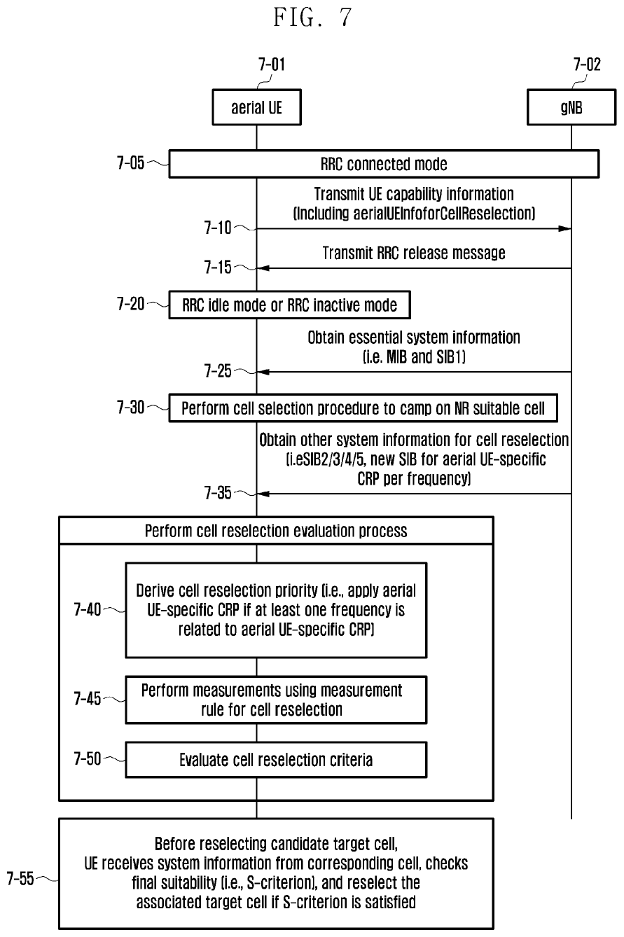

FIG. 7 is a diagram depicting a cell reselection procedure performed by an aerial UE in a next-generation mobile communication system according to an embodiment of the disclosure.

The UE according to an embodiment of the disclosure may be referred to as an aerial UE. For example, an aerial UE may be a UE with uncrewed aerial vehicle (UAV) functionality or may mean a drone. The aerial UE may receive an UAV service while flying at a specific altitude.

With reference to FIG. 7, the aerial UE 7-01 may establish an RRC connection with the NR base station 7-02 and remain in RRC connected mode (RRC_CONNECTED) (7-05).

At step 7-10, the aerial UE 7-01 may transmit a UE capability information message to the NR base station 7-02. This message may include the following information.
An indicator indicating whether the aerial UE 7-02 can apply the cell reselection priority for the aerial UE broadcasted in the system information in RRC idle mode (RRC_IDLE) or RRC inactive mode (RRC_INACTIVE). For example, this indicator may be referred to as, but not limited to, aerial UE Info for cell reselection.

At step 7-15, the NR base station 7-02 may transmit an RRC connection release message (RRC Release message) to the aerial UE 7-01.

Upon receiving the RRC Release message, at step 7-20, the aerial UE 7-01 may transition to RRC idle mode or RRC inactive mode. Specifically, when receiving an RRC Release message including suspend Config information, the aerial UE 7-01 may transition to RRC inactive mode, otherwise it may transition to RRC idle mode.

At step 7-25, the aerial UE 7-01 in RRC idle mode or RRC inactive mode may obtain essential system information. The essential system information may indicate Master Information Block (MIB) and System Information Block 1 (SIB1).

At step 7-30, the aerial UE 7-01 in RRC idle mode or RRC inactive mode may perform a cell selection procedure to camp on an NR suitable cell.

At step 7-35, the UE 7-01 in RRC idle mode or RRC inactive mode may obtain system information (e.g., SIB2, SIB3, SIB4, SIB5, new SIB) containing cell reselection information from the serving cell 7-02 to perform a cell reselection evaluation process. It is proposed that the serving cell according to an embodiment of the disclosure broadcasts one or two cell reselection priority (referred to as CRP) values per frequency. Specifically,
At least one of a first CRP (legacy CRP) or a second CRP (CRP for aerial UE) of the serving frequency may be broadcast in SIB2.
At least one of a first CRP (legacy CRP) or a second CRP (CRP for aerial UE) per NR inter-frequency may be broadcast in SIB4.
At least one of a first CRP (legacy CRP) or a second CRP (CRP for aerial UE) per E-UTRAN frequency may be broadcast in SIB5.
If no second CRP (CRP for aerial UE) is broadcast in the above system information, a second CRP (CRP for aerial UE) per frequency may be broadcast in new SIB.

The CRP may indicate at least one of a cell reselection priority IE (information element) or a cell reselection subpriority IE. As in the above-described embodiment, the cell reselection priority IE may store an integer value (e.g., an integer value from 0 to 7), and the cell reselection subpriority IE may store a decimal value (e.g., a decimal value among 0.2, 0.4, 0.6, 0.8). If only one of the two IEs is signaled, the UE 7-01 may derive the cell reselection priority value from the signaled value, and if both IEs are signaled, the UE may derive the cell reselection priority value by adding the two signaled values.

The aerial UE 7-01 in RRC idle mode or RRC inactive mode may perform a cell reselection evaluation process. The cell reselection evaluation process may refer to a series of processes for determining reselection priorities (reselection priorities handling), performing frequency measurements according to the determined reselection priorities by applying measurement rules for cell reselection, and evaluating cell reselection criteria correspondingly to reselect a cell.

At step 7-40, the aerial UE 7-01 in RRC idle mode or RRC inactive mode may derive the reselection priority based on the system information received at step 7-25. The UE 7-01 may determine the reselection priority only for the frequency for which a cell reselection priority value is broadcast in the system information. It is proposed that the UE 7-01 according to the disclosure determines the reselection priority only for the frequency for which the second CRP is broadcast if the second CRP is broadcast on at least one frequency. That is, the UE 7-01 has a characteristic of not deriving the reselection priority for a frequency on which only the first CRP is broadcast. Since the reselection priority is derived based on the serving frequency, if the second CRP is not broadcast for the serving frequency, the UE 7-01 may derive the reselection priority by applying the first CRP or may determine the serving frequency as the lowest priority and derive the reselection priority for the remaining frequencies. The method by which the UE 7-01 derives the frequency-specific reselection priority may follow the above-described embodiment. The advantage of the disclosure is that the network operator can efficiently manage frequencies by allowing the aerial UE 7-01 to apply only the second CRP.

At step 7-45, the aerial UE 7-01 in RRC idle mode or RRC inactive mode may perform frequency measurement for cell reselection. At this time, to minimize battery consumption, the UE 7-01 may perform frequency measurement according to the cell reselection priority determined at step 7-40 by using the measurement rule of the above-described embodiment. For example, the measurement rule and measurement operation described at step 5-45 may be applied at step 7-45.

At step 7-50, the aerial UE 7-01 in RRC idle mode or RRC inactive state may determine a cell satisfying the cell reselection criteria based on the measurement value obtained at step 7-45 for cell reselection. This may follow the above-described embodiment. For example, the cell reselection operation described at step 5-50 may be applied at step 7-50. For reference, in the disclosure, a list of cells that the aerial UE 7-01 can reselect (e.g., a PCI list for cell reselection for aerial UE) may be broadcast, and only cells belonging to the broadcasted cell list may be reselected. Alternatively, a list of cells that the aerial UE 7-01 cannot reselect may be broadcast, and only cells not belonging to the broadcasted cell list may be reselected. For reference, the parameter applied to Equation 2 (e.g., Q_{offset}) may be separately broadcast in system information, and the UE 7-01 may apply it to perform ranking of cells (indicating Equation 2).

At step 7-55, before finally reselecting a candidate target cell, the aerial UE 7-01 in RRC idle mode or RRC inactive state receives system information (e.g., MIB or SIB1) broadcasted by the candidate target cell, and determines whether the reception level (Srxlev) and reception quality (Squal) of the candidate target cell satisfy the cell selection criterion called S-criterion (Equation 1) (Srxlev>0 AND Squal>0) based on the received system information. If Equation 1 is satisfied and the candidate target cell is suitable, the UE 7-01 may reselect the candidate target cell.

The configuration identical to the configuration described in the example of FIG. 5 or FIG. 6 is omitted from the description in the example of FIG. 7, so for the description of the procedure and message corresponding to FIG. 5 or FIG. 6 in the example of FIG. 7, refer to the description in FIG. 5 or FIG. 6.

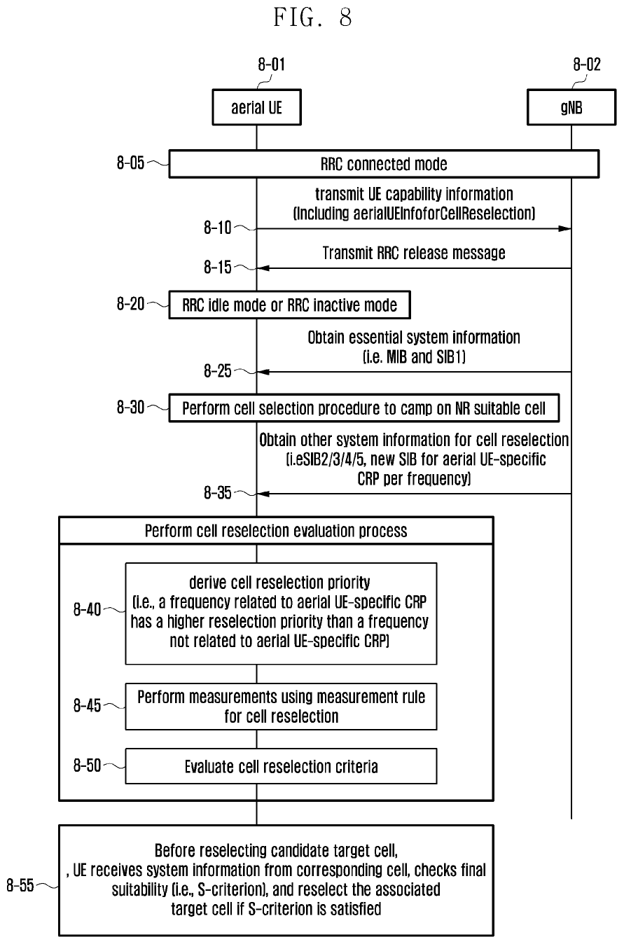

FIG. 8 is a diagram depicting a cell reselection procedure performed by an aerial UE in a next-generation mobile communication system according to an embodiment of the disclosure.

The UE according to an embodiment of the disclosure may be referred to as an aerial UE. For example, an aerial UE may be a UE with uncrewed aerial vehicle (UAV) functionality or may mean a drone. In other words, the aerial UE may receive an UAV service while flying at a specific altitude.

With reference to FIG. 8, the aerial UE 8-01 may establish an RRC connection with the NR base station 8-02 and remain in RRC connected mode (RRC_CONNECTED) (8-05).

At step 8-10, the aerial UE 8-01 may transmit a UE capability information message to the NR base station 8-02. This message may include the following information.
An indicator indicating whether the aerial UE can apply the cell reselection priority for the aerial UE broadcasted in the system information in RRC idle mode (RRC_IDLE) or RRC inactive mode (RRC_INACTIVE). This indicator may be referred to as, but not limited to, aerial UE Info for cell reselection.

At step 8-15, the NR base station 8-02 may transmit an RRC connection release message (RRC Release message) to the aerial UE 8-01.

Upon receiving the RRC Release message, at step 8-20, the aerial UE 8-01 may transition to RRC idle mode or RRC inactive mode. Specifically, when receiving an RRC Release message including suspend Config information, the aerial UE 8-01 may transition to RRC inactive mode, otherwise it may transition to RRC idle mode.

At step 8-25, the aerial UE 8-01 in RRC idle mode or RRC inactive mode may obtain essential system information. The essential system information may indicate Master Information Block (MIB) and System Information Block 1 (SIB1).

At step 8-30, the aerial UE 8-01 in RRC idle mode or RRC inactive mode may perform a cell selection procedure to camp on an NR suitable cell.

At step 8-35, the UE 8-01 in RRC idle mode or RRC inactive mode may obtain system information (e.g., SIB2, SIB3, SIB4, SIB5, new SIB) containing cell reselection information from the serving cell 8-02 to perform a cell reselection evaluation process. It is proposed that the serving cell according to an embodiment of the disclosure broadcasts one or two cell reselection priority (referred to as CRP) values per frequency. Specifically,
At least one of a first CRP (legacy CRP) or a second CRP (CRP for aerial UE) of the serving frequency may be broadcast in SIB2.
At least one of a first CRP (legacy CRP) or a second CRP (CRP for aerial UE) per NR inter-frequency may be broadcast in SIB4.
At least one of a first CRP (legacy CRP) or a second CRP (CRP for aerial UE) per E-UTRAN frequency may be broadcast in SIB5.
If no second CRP (CRP for aerial UE) is broadcast in the above system information, the second CRP (CRP for aerial UE) per frequency may be broadcast in new SIB.

The CRP may indicate at least one of a cell reselection priority IE (information element) or a cell reselection subpriority IE. As in the above-described embodiment, the cell reselection priority IE may store an integer value (e.g., an integer value from 0 to 7), and the cell reselection subpriority IE may store a decimal value (e.g., a decimal value among 0.2, 0.4, 0.6, 0.8). If only one of the two IEs is signaled, the UE 8-01 may derive the cell reselection priority value from the signaled value, and if both IEs are signaled, the UE may derive the cell reselection priority value by adding the two signaled values.

The aerial UE 8-01 in RRC idle mode or RRC inactive mode may perform a cell reselection evaluation process. The cell reselection evaluation process may refer to a series of processes for determining reselection priorities (reselection priorities handling), performing frequency measurements according to the determined reselection priorities by applying measurement rules for cell reselection, and evaluating cell reselection criteria correspondingly to reselect a cell.

At step 8-40, the aerial UE 8-01 in RRC idle mode or RRC inactive mode may derive the reselection priority based on the system information received at step 8-25. The UE 8-01 may determine the reselection priority only for the frequency for which a cell reselection priority value is broadcast in the system information. The UE 8-01 according to the disclosure has a characteristic that the frequencies for which the second CRP is broadcast are always determined to have a higher reselection priority than the frequencies for which only the first CRP is broadcast. For a frequency for which the second CRP is broadcast, the reselection priority may be derived according to the second CRP value; for a frequency for which only the first CRP is broadcast, the reselection priority may be derived according to the first CRP value. For example, reference may be made to operations 5-40, 6-40 and 7-40, or the like. The method by which the UE 8-01 derives the frequency-specific reselection priority may follow the above-described embodiment. An advantage of the disclosure is that it can aid operator operations by allowing cell reselection to be performed first on frequencies for which the second CRP is supported.

At step 8-45, the aerial UE 8-01 in RRC idle mode or RRC inactive mode may perform frequency measurement for cell reselection. At this time, to minimize battery consumption, the UE 8-01 may perform frequency measurement according to the cell reselection priority determined at step 8-40 by using the measurement rule of the above-described embodiment. For example, the measurement rule and measurement operation described at step 5-45 may be applied at step 8-45.

At step 8-50, the aerial UE 8-01 in RRC idle mode or RRC inactive state may determine a cell satisfying the cell reselection criteria based on the measurement value obtained at step 8-45 for cell reselection. This may follow the above-described embodiment. For example, the measurement rules and measurement operations described at step 5-45 may be applied at step 8-45.

At step 8-55, before finally reselecting a candidate target cell, the aerial UE 8-01 in RRC idle mode or RRC inactive state receives system information (e.g., MIB or SIB1) broadcasted by the candidate target cell, and determines whether the reception level (Srxlev) and reception quality (Squal) of the candidate target cell satisfy the cell selection criterion called S-criterion (Equation 1) (Srxlev>0 AND Squal>0) based on the received system information. If Equation 1 is satisfied and the candidate target cell is suitable, the UE 8-01 may reselect the candidate target cell.

The configuration identical to the configuration described in the example of FIG. 5, FIG. 6 or FIG. 7 is omitted from the description in the example of FIG. 8, so for the description of the procedure and message corresponding to FIG. 5, FIG. 6 or FIG. 7 in the example of FIG. 8, refer to the description in FIG. 5, FIG. 6 or FIG. 7.

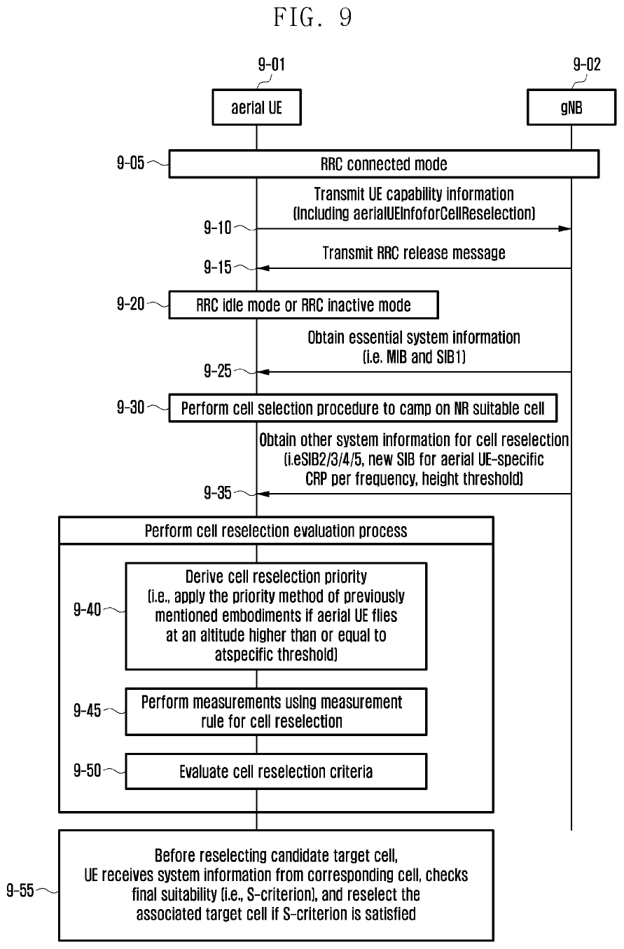

FIG. 9 is a diagram depicting a cell reselection procedure performed by an aerial UE in a next-generation mobile communication system according to an embodiment of the disclosure.

The UE according to an embodiment of the disclosure may be referred to as an aerial UE. For example, an aerial UE may be a UE with uncrewed aerial vehicle (UAV) functionality or may mean a drone. In other words, the aerial UE may receive an UAV service while flying at a specific altitude.

With reference to FIG. 9, the aerial UE 9-01 may establish an RRC connection with the NR base station 9-02 and remain in RRC connected mode (RRC_CONNECTED) (9-05).

At step 9-10, the aerial UE 9-01 may transmit a UE capability information message to the NR base station 9-02. This message may include the following information.

An indicator indicating whether the aerial UE can apply the cell reselection priority for the aerial UE broadcasted in the system information in RRC idle mode (RRC_IDLE) or RRC inactive mode (RRC_INACTIVE). This indicator may be referred to as, but not limited to, aerial UE Info for cell reselection.

At step 9-15, the NR base station 9-02 may transmit an RRC connection release message (RRC Release message) to the aerial UE 9-01.

Upon receiving the RRC Release message, at step 9-20, the aerial UE 9-01 may transition to RRC idle mode or RRC inactive mode. Specifically, when receiving an RRC Release message including suspend Config information, the aerial UE 9-01 may transition to RRC inactive mode, otherwise it may transition to RRC idle mode.

At step 9-25, the aerial UE 9-01 in RRC idle mode or RRC inactive mode may obtain essential system information. The essential system information may indicate Master Information Block (MIB) and System Information Block 1 (SIB1).

At step 9-30, the aerial UE 9-01 in RRC idle mode or RRC inactive mode may perform a cell selection procedure to camp on an NR suitable cell.

At step 9-35, the UE 9-01 in RRC idle mode or RRC inactive mode may obtain system information (e.g., SIB2, SIB3, SIB4, SIB5, new SIB) containing cell reselection information from the serving cell 9-02 to perform a cell reselection evaluation process. It is proposed that the serving cell according to an embodiment of the disclosure broadcasts two cell reselection priority (referred to as CRP) values per frequency. Specifically,
At least one of a first CRP (legacy CRP) or a second CRP (CRP for aerial UE) of the serving frequency may be broadcast in SIB2.
At least one of a first CRP (legacy CRP) or a second CRP (CRP for aerial UE) per NR inter-frequency may be broadcast in SIB4.
At least one of a first CRP (legacy CRP) or a second CRP (CRP for aerial UE) per E-UTRAN frequency may be broadcast in SIB5.
If no second CRP (CRP for aerial UE) is broadcast in the above system information, a second CRP (CRP for aerial UE) per frequency may be broadcast in new SIB.

The CRP may indicate at least one of a cell reselection priority IE (information element) or a cell reselection subpriority IE. As in the above-described embodiment, the cell reselection priority IE may store an integer value (e.g., an integer value from 0 to 7), and the cell reselection subpriority IE may store a decimal value (e.g., a decimal value among 0.2, 0.4, 0.6, 0.8). If only one of the two IEs is signaled, the UE may derive the cell reselection priority value from the signaled value, and if both IEs are signaled, the UE may derive the cell reselection priority value by adding the two signaled values.

Additionally, in the disclosure, a height threshold that is commonly applied regardless of frequencies or a frequency-specific height threshold may be broadcast in the system information.

The aerial UE 9-01 in RRC idle mode or RRC inactive mode may perform a cell reselection evaluation process. The cell reselection evaluation process may refer to a series of processes for determining reselection priorities (reselection priorities handling), performing frequency measurements according to the determined reselection priorities by applying measurement rules for cell reselection, and evaluating cell reselection criteria correspondingly to reselect a cell.

At step 9-40, the aerial UE 9-01 in RRC idle mode or RRC inactive mode may derive the reselection priority based on the system information received at step 9-25. The UE 9-01 may determine the reselection priority only for the frequency for which a cell reselection priority value is broadcast in the system information. The UE 9-01 according to the disclosure may determine, if the UE flies at or above a specific height threshold broadcasted in the system information, the reselection priority by applying the second CRP associated with the specific height threshold (second CRP associated with height 1 threshold) to at least one of the above-described embodiments. If the UE flies at or below the height threshold broadcasted in the system information, it may determine the reselection priority according to the fifth embodiment. For reference, since the interference caused by the aerial UE varies depending on the flight height, it can be efficient for network management to determine the reselection priority according to the flight height.

At step 9-45, the aerial UE 9-01 in RRC idle mode or RRC inactive mode may perform frequency measurement for cell reselection. At this time, to minimize battery consumption, the UE 9-01 may perform frequency measurement according to the cell reselection priority determined at step 9-40 by using the measurement rule of the above-described embodiment. For example, the measurement rule and measurement operation described at step 5-45 may be applied at step 9-45.

At step 9-50, the aerial UE 9-01 in RRC idle mode or RRC inactive state may determine a cell satisfying the cell reselection criteria based on the measurement value obtained at step 9-45 for cell reselection. This may follow the above-described embodiment. For example, the cell reselection operation described at step 5-50 may be applied at step 9-50.

At step 9-55, before finally reselecting a candidate target cell, the aerial UE 9-01 in RRC idle mode or RRC inactive state receives system information (e.g., MIB or SIB1) broadcasted by the candidate target cell, and determines whether the reception level (Srxlev) and reception quality (Squal) of the candidate target cell satisfy the cell selection criterion called S-criterion (Equation 1) (Srxlev>0 AND Squal>0) based on the received system information. If Equation 1 is satisfied and the candidate target cell is suitable, the UE 9-01 may reselect the candidate target cell.

The configuration identical to the configuration described in the example of FIG. 5, FIG. 6, FIG. 7 or FIG. 8 is omitted from the description in the example of FIG. 9, so for the description of the procedure and message corresponding to FIG. 5, FIG. 6, FIG. 7 or FIG. 8 in the example of FIG. 9, refer to the description in FIG. 5, FIG. 6, FIG. 7 or FIG. 8.

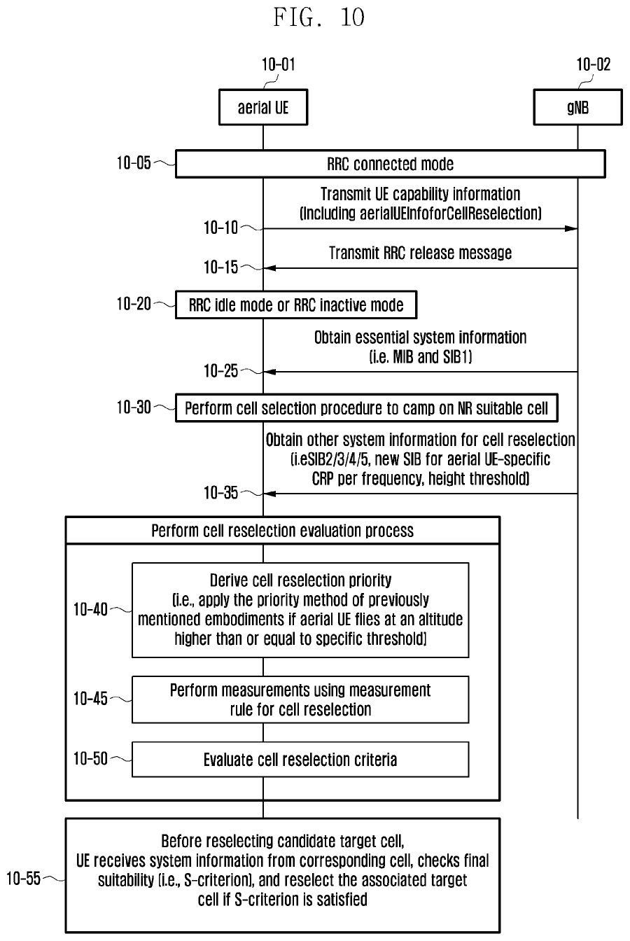

FIG. 10 is a diagram depicting a cell reselection procedure performed by an aerial UE in a next-generation mobile communication system according to an embodiment of the disclosure.

The UE according to an embodiment of the disclosure may be referred to as an aerial UE. For example, an aerial UE may be a UE with uncrewed aerial vehicle (UAV) functionality or may mean a drone. In other words, the aerial UE may receive an UAV service while flying at a specific altitude.

With reference to FIG. 10, the aerial UE 10-01 may establish an RRC connection with the NR base station 10-02 and remain in RRC connected mode (RRC_CONNECTED) (10-05).

At step 10-10, the aerial UE 10-01 may transmit a UE capability information message to the NR base station 10-02. This message may include the following information.

An indicator indicating whether the aerial UE can apply the cell reselection priority for the aerial UE broadcasted in the system information in RRC idle mode (RRC_IDLE) or RRC inactive mode (RRC_INACTIVE). This indicator may be referred to as, but not limited to, aerial UE Info for cell reselection.

At step 10-15, the NR base station 10-02 may transmit an RRC connection release message (RRC Release message) to the aerial UE 10-01.

Upon receiving the RRC Release message, at step 10-20, the aerial UE 10-01 may transition to RRC idle mode or RRC inactive mode. Specifically, when receiving an RRC Release message including suspend Config information, the aerial UE 10-01 may transition to RRC inactive mode, otherwise it may transition to RRC idle mode.

At step 10-25, the aerial UE 10-01 in RRC idle mode or RRC inactive mode may obtain essential system information. The essential system information may indicate Master Information Block (MIB) and System Information Block 1 (SIB1).

At step 10-30, the aerial UE 10-01 in RRC idle mode or RRC inactive mode may perform a cell selection procedure to camp on an NR suitable cell.

At step 10-35, the UE 10-01 in RRC idle mode or RRC inactive mode may obtain system information (e.g., SIB2, SIB3, SIB4, SIB5, new SIB) containing cell reselection information from the serving cell 10-02 to perform a cell reselection evaluation process. It is proposed that the serving cell according to an embodiment of the disclosure broadcasts multiple cell reselection priority (referred to as CRP) values per frequency. Specifically,
At least one of a first CRP (legacy CRP) or one or multiple second CRPs (CRP for aerial UE) of the serving frequency may be broadcast in SIB2.
At least one of a first CRP (legacy CRP) or one or multiple second CRPs (CRP for aerial UE) per NR inter-frequency may be broadcast in SIB4.
At least one of a first CRP (legacy CRP) or one or multiple second CRPs (CRP for aerial UE) per E-UTRAN frequency may be broadcast in SIB5.
If no second CRP (CRP for aerial UE) is broadcast in the above system information, one or multiple second CRPs (CRP for aerial UE) per frequency may be broadcast in new SIB.

The CRP may indicate at least one of a cell reselection priority IE (information element) or a cell reselection subpriority IE. As in the above-described embodiment, the cell reselection priority IE may store an integer value (e.g., an integer value from 0 to 7), and the cell reselection subpriority IE may store a decimal value (e.g., a decimal value among 0.2, 0.4, 0.6, 0.8). If only one of the two IEs is signaled, the UE 10-01 may derive the cell reselection priority value from the signaled value, and if both IEs are signaled, the UE may derive the cell reselection priority value by adding the two signaled values.

Additionally, in the disclosure, one or multiple height thresholds that are commonly applied regardless of frequencies or one or more height thresholds for each frequency may be broadcast in the system information. For reference, in the disclosure, a first CRP or one second CRP among the one or multiple second CRPs may be mapped for each height threshold.

The aerial UE 10-01 in RRC idle mode or RRC inactive mode may perform a cell reselection evaluation process. The cell reselection evaluation process may refer to a series of processes for determining reselection priorities (reselection priorities handling), performing frequency measurements according to the determined reselection priorities by applying measurement rules for cell reselection, and evaluating cell reselection criteria correspondingly to reselect a cell.

At step 10-40, the aerial UE 10-01 in RRC idle mode or RRC inactive mode may derive the reselection priority based on the system information received at step 10-25. The UE 10-01 may determine the reselection priority only for the frequency for which a cell reselection priority value is broadcast in the system information. The UE 10-01 according to the disclosure may determine, if the UE flies at or above a specific height threshold broadcasted in the system information (e.g., height 1 threshold<=aerial UE's altitude<height 2 threshold), the reselection priority by applying the second CRP associated with the specific height threshold (second CRP associated with height 1 threshold) to at least one of the above-described embodiments. If the UE 10-01 flies at or below the lowest height threshold broadcasted in the system information, it may determine the reselection priority according to the fifth embodiment. For reference, since the interference caused by the aerial UE varies depending on the flight height, it can be efficient for network management to determine the reselection priority according to the flight height.

At step 10-45, the aerial UE 10-01 in RRC idle mode or RRC inactive mode may perform frequency measurement for cell reselection. At this time, to minimize battery consumption, the UE may perform frequency measurement according to the cell reselection priority determined at step 10-40 by using the measurement rule of the above-described embodiment. For example, the measurement rule and measurement operation described at step 5-45 may be applied at step 10-45.

At step 10-50, the aerial UE 10-01 in RRC idle mode or RRC inactive state may determine a cell satisfying the cell reselection criteria based on the measurement value obtained at step 10-45 for cell reselection. This may follow the above-described embodiment. For example, the cell reselection operation described at step 5-50 may be applied at step 6-50.

For reference, in the disclosure, a list of cells that the aerial UE 10-01 can reselect (e.g., a PCI list for cell reselection for aerial UE) may be broadcast, and only cells belonging to the broadcasted cell list may be reselected. At this time, the UE 10-01 may perform reselection by applying the cell list only when it flies at or above a specific height threshold. Alternatively, a list of cells that the aerial UE 10-01 cannot reselect may be broadcast, and only cells not belonging to the broadcasted cell list may be reselected. At this time, the UE 10-01 may perform reselection by applying the cell list only when it flies at or above a specific height threshold. For reference, the parameter applied to Equation 2 (e.g., Q_{offset}) may be separately broadcast in system information, and the UE 10-01 may apply it to perform ranking of cells (indicating Equation 2). At this time, the parameter may be separately broadcast in system information only when flying at or above a specific height threshold, and the UE 10-01 may perform ranking of cells by applying the separately signaled parameter to Equation 2.

At step 10-55, before finally reselecting a candidate target cell, the aerial UE 10-01 in RRC idle mode or RRC inactive state receives system information (e.g., MIB or SIB1) broadcasted by the candidate target cell, and determines whether the reception level (Srxlev) and reception quality (Squal) of the candidate target cell satisfy the cell selection criterion called S-criterion (Equation 1) (Srxlev>0 AND Squal>0) based on the received system information. If Equation 1 is satisfied and the candidate target cell is suitable, the UE 10-01 may reselect the candidate target cell.

The cell reselection and priority determination method according to the disclosure has been described through FIGS. 5, 6, 7, 8, 9 and 10. FIGS. 5, 6, 7, 8, 9 and 10 are separated for convenience of explanation, and since the purpose of cell reselection and priority determination is the same, some of configurations of FIGS. 5, 6, 7, 8, 9 and 10 may be combined and carried out, without contradicting each other. In addition, procedures identical or similar to the preceding examples are omitted or summarized, and descriptions of corresponding procedures, corresponding information, and corresponding messages in FIGS. 5, 6, 7, 8, 9 and 10 may refer to descriptions in different examples.

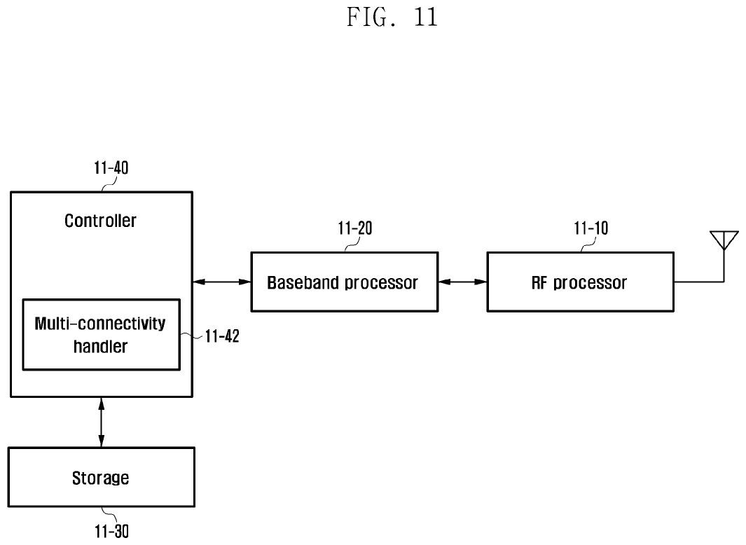

FIG. 11 is a diagram illustrating the structure of a UE according to an embodiment of the disclosure.

With reference to the drawing, the UE may include a radio frequency (RF) processor 11-10, a baseband processor 11-20, a storage 11-30, and a controller 11-40. Additionally, the controller 11-40 may include a multi-connectivity handler 11-42. In various embodiments of the disclosure, the UE may be an aerial UE.

The RF processor 11-10 performs a function for transmitting and receiving a signal through a radio channel, such as signal band conversion and amplification. That is, the RF processor 11-10 performs up-conversion of a baseband signal provided from the baseband processor 11-20 into an RF-band signal and transmit it through an antenna, and performs down-conversion of an RF-band signal received through an antenna into a baseband signal. For example, the RF processor 11-10 may include a transmission filter, a reception filter, an amplifier, a mixer, an oscillator, a digital-to-analog converter (DAC), and an analog-to-digital converter (ADC). Although only one antenna is illustrated in the drawing, the UE may be provided with a plurality of antennas. Also, the RF processor 11-10 may include a plurality of RF chains. Further, the RF processor 11-10 may perform beamforming. For beamforming, the RF processor 11-10 may adjust phases and magnitudes of individual signals transmitted and received through the plural antennas or antenna elements. Further, the RF processor may perform MIMO (multi input multi output), and may receive several layers during an MIMO operation.

The baseband processor 11-20 performs conversion between a baseband signal and a bit stream in accordance with the physical layer specification of the system. For example, during data transmission, the baseband processor 11-20 generates complex symbols by encoding and modulating a transmission bit stream. Further, during data reception, the baseband processor 11-20 restores a reception bit stream by demodulating and decoding a baseband signal provided from the RF processor 11-10. For example, in the case of utilizing orthogonal frequency division multiplexing (OFDM), for data transmission, the baseband processor 11-20 generates complex symbols by encoding and modulating a transmission bit stream, maps the complex symbols to subcarriers, and composes OFDM symbols through inverse fast Fourier transform (IFFT) operation and cyclic prefix (CP) insertion. Further, for data reception, the baseband processor 11-20 divides a baseband signal provided from the RF processor 11-10 in units of OFDM symbols, restores the signals mapped to subcarriers through fast Fourier transform (FFT), and restores the reception bit stream through demodulation and decoding.

The baseband processor 11-20 and the RF processor 11-10 transmit and receive signals as described above. The baseband processor 11-20 and the RF processor 11-10 may be called a transmitter, a receiver, a transceiver, or a communication unit. Further, to support different radio access technologies, at least one of the baseband processor 11-20 or the RF processor 11-10 may include a plurality of communication modules. In addition, to process signals of different frequency bands, at least one of the baseband processor 11-20 or the RF processor 11-10 may include different communication modules. For example, the different radio access technologies may include a wireless LAN (e.g., IEEE 802.11), a cellular network (e.g., LTE), and the like. In addition, the different frequency bands may include a super high frequency (SHF) band (e.g., 2.NRHz, NRhz) and a millimeter wave (mmWave) band (e.g., 60 GHz).

The storage 11-30 stores data such as basic programs, application programs, and configuration information for the operation of the UE. In particular, the storage 11-30 may store information on a second access node that performs wireless communication using a second radio access technology. The storage 11-30 provides stored data in response to a request from the controller 11-40.

The controller 11-40 controls the overall operation of the UE. For example, the controller 11-40 transmits and receives signals through the baseband processor 11-20 and the RF processor 11-10. Further, the controller 11-40 writes or reads data to or from the storage 11-30. To this end, the controller 11-40 may include at least one processor. For example, the controller 11-40 may include a communication processor (CP) for controlling communication and an application processor (AP) for controlling higher layers such as application programs. The controller 11-40 may control the operation of the UE according to various embodiments of the disclosure.

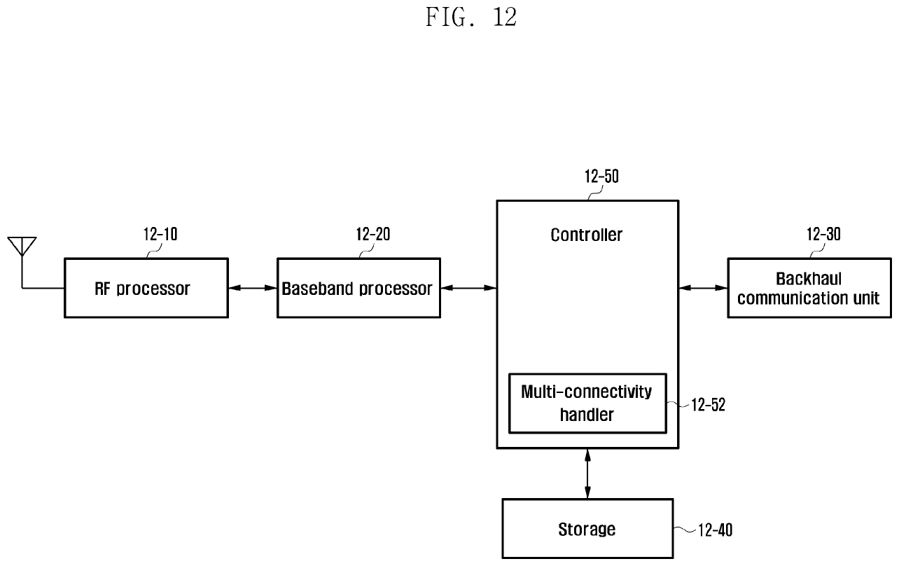

FIG. 12 is a diagram illustrating the structure of a base station according to an embodiment of the disclosure.

As shown in the drawing, the base station includes an RF processor 12-10, a baseband processor 12-20, a backhaul communication unit 12-30, a storage 12-40, and a controller 12-50. Additionally, the controller 12-50 may include a multi-connectivity handler 12-52.

The RF processor 12-10 performs a function for transmitting and receiving a signal through a radio channel, such as signal band conversion and amplification. That is, the RF processor 12-10 performs up-conversion of a baseband signal provided from the baseband processor 12-20 into an RF-band signal and transmits the converted signal through an antenna, and performs down-conversion of an RF-band signal received through an antenna into a baseband signal. For example, the RF processor 12-10 may include a transmission filter, a reception filter, an amplifier, a mixer, an oscillator, a DAC, and an ADC. Although only one antenna is illustrated in the drawing, the first access node may be provided with a plurality of antennas. Additionally, the RF processor 12-10 may include a plurality of RF chains. Further, the RF processor 12-10 may perform beamforming. For beamforming, the RF processor 12-10 may adjust phases and amplitudes of individual signals transmitted and received through plural antennas or antenna elements. The RF processor may perform downlink MIMO operation by transmitting one or more layers.

The baseband processor 12-20 performs conversion between a baseband signal and a bit stream in accordance with the physical layer specification of a first radio access technology. For example, for data transmission, the baseband processor 12-20 generates complex symbols by encoding and modulating a transmission bit stream. Further, for data reception, the baseband processor 12-20 restores a reception bit stream by demodulating and decoding a baseband signal provided from the RF processor 12-10. For example, in the case of utilizing OFDM, for data transmission, the baseband processor 12-20 generates complex symbols by encoding and modulating a transmission bit stream, maps the complex symbols to subcarriers, and composes OFDM symbols through IFFT operation and CP insertion. Further, for data reception, the baseband processor 12-20 divides a baseband signal provided from the RF processor 12-10 in units of OFDM symbols, restores the signals mapped to subcarriers through FFT operation, and restores the reception bit stream through demodulation and decoding. The baseband processor 12-20 and the RF processor 12-10 transmits and receives signals as described above. Hence, the baseband processor 12-20 and the RF processor 12-10 may be called a transmitter, a receiver, a transceiver, a communication unit, or a wireless communication unit.

The backhaul communication unit 12-30 provides an interface for communication with other nodes in the network. That is, the backhaul communication unit 12-30 converts a bit stream, which is to be transmitted from the base station to another node, for example, a secondary base station or the core network, into a physical signal, and converts a physical signal received from another node into a bit stream.

The storage 12-40 stores data such as basic programs, application programs, and configuration information for the operation of the base station. In particular, the storage 12-40 may store information on a bearer allocated to a connected UE and measurement results reported from the connected UE. Further, the storage 12-40 may store information used as a criterion for determining whether to provide or suspend multi-connectivity to the UE. In addition, the storage 12-40 provides stored data in response to a request from the controller 12-50.

The controller 12-50 controls the overall operation of the base station. For example, the controller 12-50 transmits and receives signals through the baseband processor 12-20 and the RF processor 12-10 or through the backhaul communication unit 12-30. Further, the controller 12-50 writes or reads data to or from the storage 12-40. To this end, the controller 12-50 may include at least one processor. The controller 12-50 may control the operation of the base station according to various embodiments of the disclosure.

The methods according to the embodiments described in the claims or specification of the disclosure may be implemented in the form of hardware, software, or a combination thereof.

When implemented in software, a computer-readable storage medium storing one or more programs (software modules) may be provided. The one or more programs stored in the computer-readable storage medium may be configured to be executable by one or more processors of an electronic device. The one or more programs may include instructions that cause the electronic device to execute the methods according to the embodiments described in the claims or specification of the disclosure.

Such a program (software module, software) may be stored in a random access memory, a nonvolatile memory such as a flash memory, a read only memory (ROM), an electrically erasable programmable read only memory (EEPROM), a magnetic disc storage device, a compact disc ROM (CD-ROM), a digital versatile disc (DVD), other types of optical storage devices, or a magnetic cassette. Or, such a program may be stored in a memory composed of a combination of some or all of them. In addition, a plurality of component memories may be included.

In addition, such a program may be stored in an attachable storage device that can be accessed through a communication network such as the Internet, an intranet, a local area network (LAN), a wide LAN (WLAN), or a storage area network (SAN), or through a communication network composed of a combination thereof. Such a storage device may access the equipment that carries out an embodiment of the disclosure through an external port. In addition, a separate storage device on a communication network may access the equipment that carries out an embodiment of the disclosure.

In the embodiments of the disclosure described above, the elements included in the disclosure are expressed in a singular or plural form according to the presented specific embodiment. However, the singular or plural expression is appropriately selected for ease of description according to the presented situation, and the disclosure is not limited by a single element or plural elements. Those elements described in a plural form may be configured as a single element, and those elements described in a singular form may be configured as plural elements.

Meanwhile, the embodiments of the disclosure disclosed in the present specification and drawings are only provided as specific examples to easily explain the technical details of the disclosure and to aid understanding of the disclosure, and are not intended to limit the scope of the disclosure. That is, it will be apparent to those of ordinary skill in the art that other modifications based on the technical idea of the disclosure can be carried out. In addition, some of the embodiments may be combined with each other if necessary for operation. For example, parts of one embodiment and another embodiment of the disclosure may be combined with each other to operate the base station and the UE. Further, the embodiments of the disclosure are applicable to other communication systems, and other modifications based on the technical ideas of the embodiments may also be carried out.

1. A method performed by a terminal having an unscrewed aerial vehicle (UAV) function in a wireless communication system, the method comprising:
receiving system information including at least one of a first cell reselection priority (CRP) or a second CRP for each of multiple frequencies from a base station;
determining cell reselection priorities for the multiple frequencies based on the system information;
performing frequency measurements based on the cell reselection priorities for the multiple frequencies; and
reselecting a cell that satisfies cell reselection criteria based on the frequency measurements,
wherein the first CRP is a CRP defined for a legacy UAV terminal, and the second CRP is a CRP defined for a terminal having a UAV function.

2. The method of claim 1,
wherein, in case that both the first CRP and the second CRP are included for a first frequency, the terminal determines a cell reselection priority for the first frequency based on the second CRP.

3. The method of claim 2,
wherein, in case that one of the first CRP or the second CRP is included for the first frequency, the terminal determines the cell reselection priority for the first frequency based on the included CRP.

4. The method of claim 1,
wherein the terminal determines cell reselection priorities only for frequencies that include the second CRP information among the multiple frequencies.

5. The method of claim 4,
wherein, in case that a serving cell of the terminal does not include the second CRP, a cell reselection priority for the serving cell is set to a lowest priority, or the cell reselection priority thereof is determined based on a first CRP of the serving cell.

6. The method of claim 1,
wherein the system information further includes information on a height threshold; and
wherein, in case that the terminal flies at an altitude higher than or equal to the height threshold, the terminal determines a cell reselection priority by using the second CRP.

7. The method of claim 1,
wherein one or multiple height thresholds are defined for each frequency in the system information; and
wherein the multiple height thresholds are mapped to multiple second CRPs.

8. The method of claim 1,
wherein, in case that at least one of first cell list information or second cell list information for a terminal having a UAV function is obtained, the terminal reselects at least one cell among cells included in the first cell list information, or reselects one cell among cells excluding cells included in the second cell list information.

9. A terminal having an unscrewed aerial vehicle (UAV) function in a wireless communication system, the terminal comprising:
a transceiver; and
a controller,
wherein the controller is configured to control:
receiving system information including at least one of a first cell reselection priority (CRP) or a second CRP for each of multiple frequencies from a base station;
determining cell reselection priorities for the multiple frequencies based on the system information;
performing frequency measurements based on the cell reselection priorities for the multiple frequencies; and
reselecting a cell that satisfies cell reselection criteria based on the frequency measurements,
wherein the first CRP is a CRP defined for a legacy UAV terminal, and the second CRP is a CRP defined for a terminal having a UAV function.

10. The terminal of claim 9,
wherein, in case that both the first CRP and the second CRP are included for a first frequency, the terminal determines a cell reselection priority for the first frequency based on the second CRP.

11. The terminal of claim 10,
wherein in case that one of the first CRP or the second CRP is included for the first frequency, the terminal determines the cell reselection priority for the first frequency based on the included CRP.

12. The terminal of claim 9,
wherein the terminal determines cell reselection priorities only for frequencies that include the second CRP information among the multiple frequencies.

13. The terminal of claim 12,
wherein, in case that a serving cell of the terminal does not include the second CRP, a cell reselection priority for the serving cell is set to a lowest priority, or the cell reselection priority thereof is determined based on a first CRP of the serving cell.

14. The terminal of claim 9,
wherein the system information further includes information on a height threshold; and
wherein, in case that the terminal flies at an altitude higher than or equal to the height threshold, the terminal determines a cell reselection priority by using the second CRP.

15. The terminal of claim 9,
wherein, in case that at least one of first cell list information or second cell list information for a terminal having a UAV function is obtained, the terminal reselects at least one cell among cells included in the first cell list information, or reselects one cell among cells excluding cells included in the second cell list information.
